(19) United States
(12) Patent Application Publication
(10) Pub. No.: US 2026/0233835 A1
(43) Pub. Date: Aug. 13, 2026

(54) BLENDED WING BODY AIRCRAFT WITH A PASSENGER COMPARTMENT

(71) Applicant: JetZero, Inc., Long Beach, CA (US)

(72) Inventor: Blaine Rawdon, Long Beach, CA (US)

(73) Assignee: JetZero, Inc., Long Beach, CA (US)

(21) Appl. No.: 19/637,906

(22) Filed: Apr. 2, 2026

Related U.S. Application Data
(63) Continuation of application No. 18/101,836, filed on Jan. 26, 2023, now abandoned.

(51) Int. Cl. B64C 39/10; B64D 39/00

(52) U.S. Cl. CPC B64C 39/10; B64D 39/00; B64C 2039/105

(57) ABSTRACT

Aspects relate to blended wing body aircraft having a passenger compartment. Blended wing body aircraft may include a freighter aircraft, a tanker aircraft, a passenger aircraft, or the like. Blended wing body aircraft may include an upper seating area, such as a passenger compartment, configured to accommodate passengers or personnel of aircraft without sacrificing space of a main region of a fuselage of the aircraft.

### CROSS REFERENCE TO RELATED APPLICATIONS

This application is a continuation of U.S. Application No. 18/101,836, filed 26-JAN-2023, which is incorporated herein in its entirety by this reference.

### FIELD OF THE INVENTION

The present invention generally relates to the field of aviation. In particular, the present invention is directed to blended wing body aircraft with upper seating.

### BACKGROUND

When aircraft are used for purposes such as cargo transport or in-flight refueling, passenger seating may be significantly reduced.

### SUMMARY OF THE DISCLOSURE

In an aspect, a blended wing body aircraft with a passenger compartment is provided. The aircraft includes a blended wing body. The blended wing body includes a lower portion and an upper portion positioned above the lower portion, where the lower potion is configured to store one or more objects. The blended wing body may also include a passenger compartment positioned in the upper portion of the blended wing body. The passenger compartment includes one or more walls and a floor adjoined to the walls, where the passenger compartment is configured to seat one or more passengers.

In another aspect, a method for use of a blended wing body aircraft with a passenger compartment. The method includes the following steps: storing one or more objects in a lower portion of a blended wing body of a blended wing body aircraft, defining a passenger compartment within an upper portion of the blended wing body, which is oriented above the lower portion, using one or more walls and a floor adjoining the one or more walls, securing one or more passengers within the passenger compartment during operation of the blended wing body aircraft.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is an illustration showing a partially transparent perspective view of an exemplary embodiment of a blended wing aircraft having a passenger compartment in accordance with one or more embodiments of the present disclosure;

FIG. 1B is an illustration showing a cross-sectional view of the blended wing aircraft taken along line 1B–1B of FIG. 1A in accordance with one or more embodiments of the present disclosure;

FIG. 2 is an illustration showing a perspective view of an exemplary embodiment of the blended wing aircraft in accordance with one or more embodiments of the present disclosure;

FIG. 3 is an illustration showing a perspective view of an exemplary embodiment of a freighter airframe with cargo arranged therein in accordance with one or more embodiments of the present disclosure;

FIG. 4 is an illustration showing a schematic diagram of an exemplary embodiment of a tanker in accordance with one or more embodiments of the present disclosure;

FIG. 5A is a block diagram showing an exemplary embodiment of a fuel offloading system including a boom;

FIG. 5B is a block diagram showing an exemplary embodiment of a fuel offloading system including a hose a drogue;

FIG. 6 is a flow diagram of an exemplary method of use of a blended wing body aircraft with a passenger compartment in accordance with one or more embodiments of the present disclosure; and FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a blended wing body aircraft having a passenger compartment and corresponding methods of use. A special purpose aircraft such as a cargo aircraft (i.e. freighter) or in-flight fueling aircraft (i.e. tanker) may be structured such that an interior space of the aircraft is used for storage instead of passenger seating or transportation due to the minimized dimensions of the interior space. For example, and without limitation, an interior space, such as a deck or cabin, of a freighter aircraft must be used for payload storage, thus, eliminating seating for passengers. Blended wing body aircraft, however, may include a special purpose aircraft, such as a freighter or tanker aircraft, providing passenger seating while still allowing for ample cargo, fuel, or equipment storage.

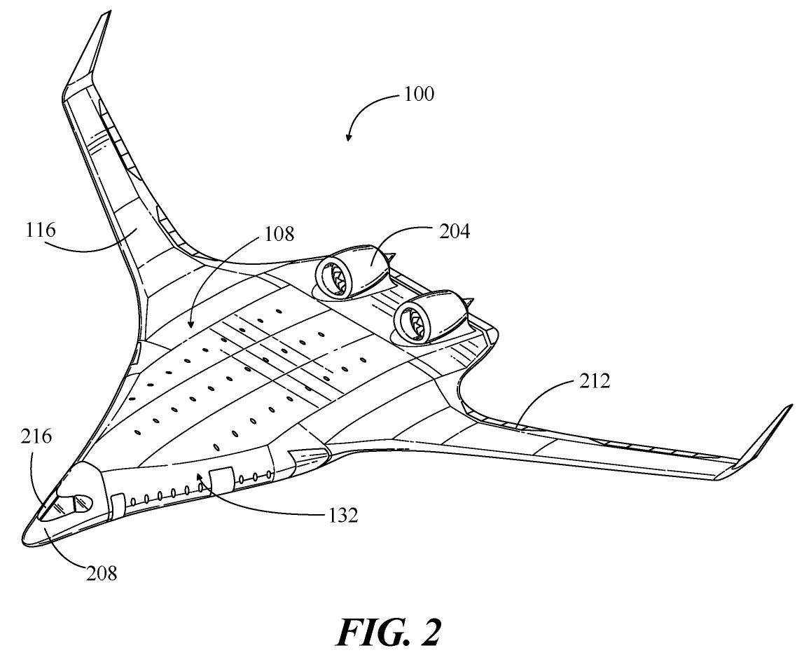

In the following description, for the purposes of explanation, numerous specific details are set forth in order to provide a thorough understanding of the present invention. For purposes of description herein, relating terms, including “upper”, “lower”, “left”, “rear”, “right”, “front”, “vertical”, “horizontal”, and derivatives thereof relate to embodiments oriented as shown for exemplary purposes in FIG. 2. Furthermore, there is no intention to be bound by any expressed or implied theory presented in this disclosure.

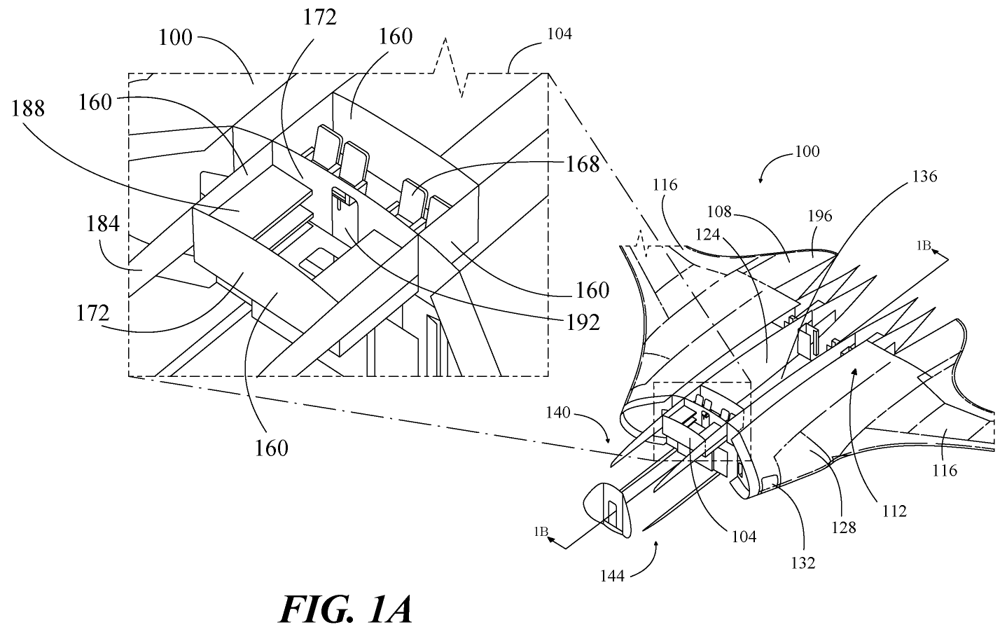

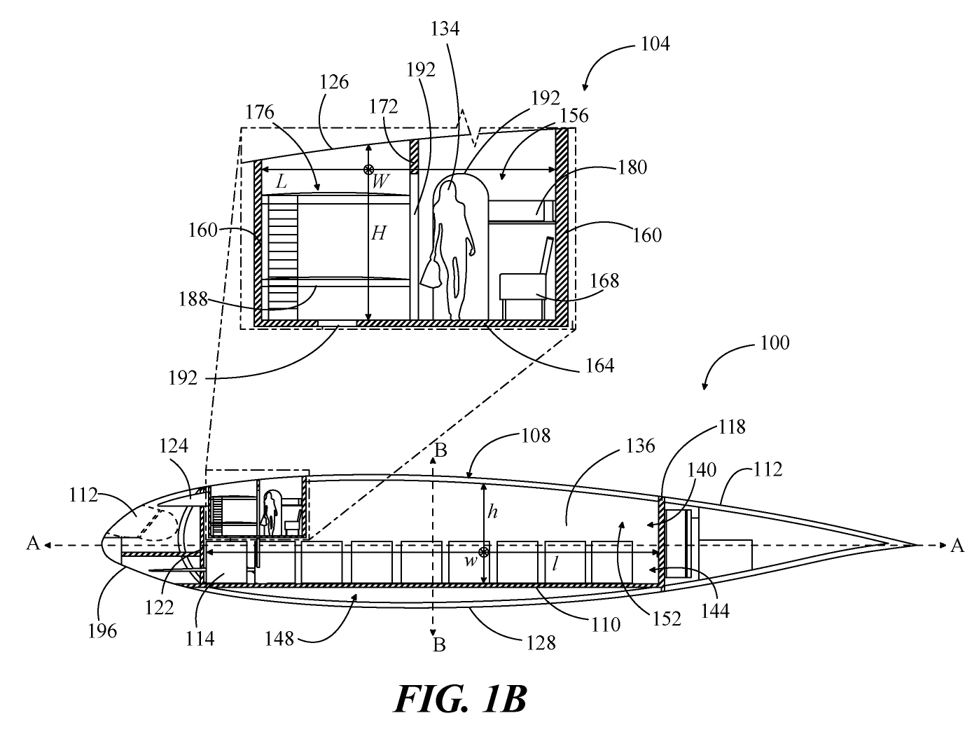

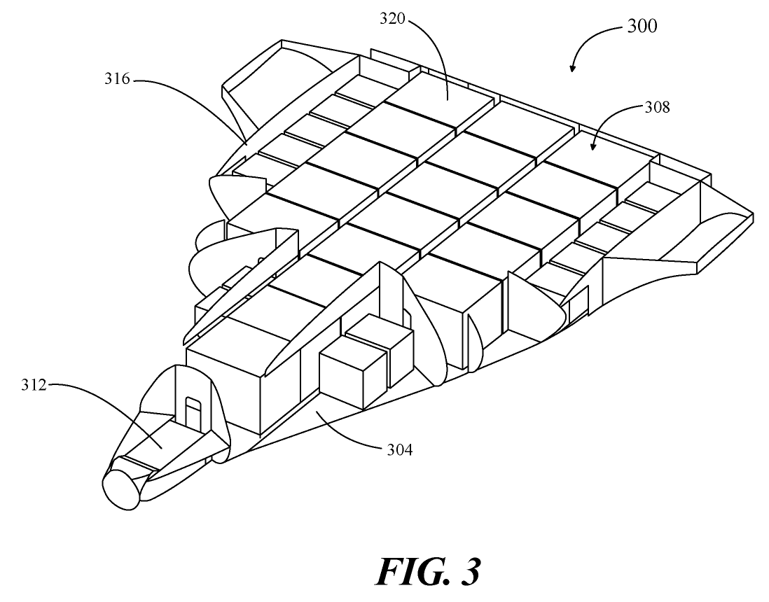

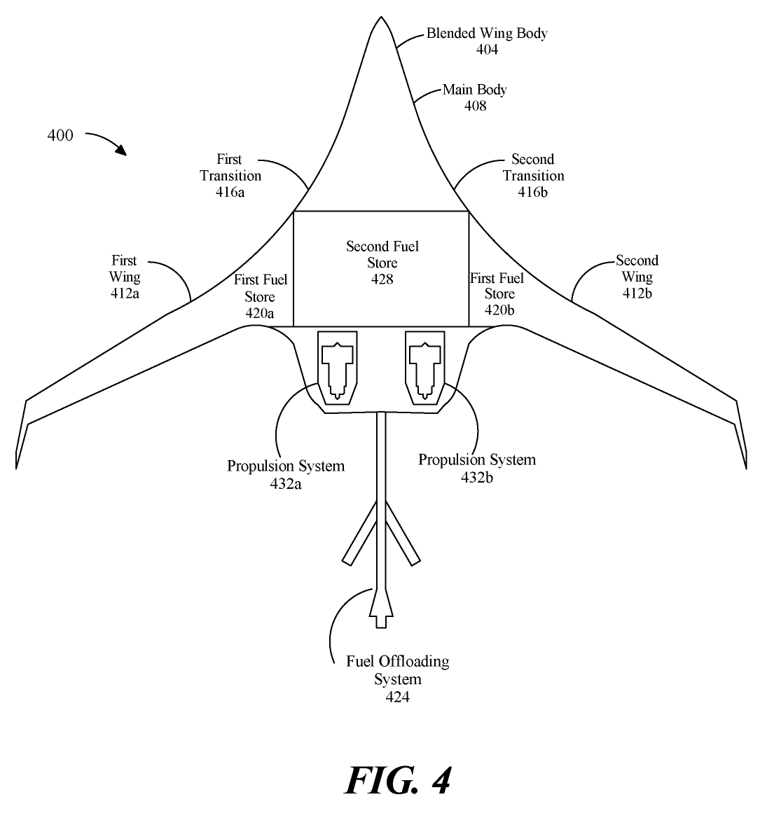

Referring now to FIG. 1A, a partially transparent view of an exemplary embodiment of a blended wing body (BWB) aircraft 100 with an upper passenger compartment 104 is shown. As referred to in this disclosure, a “blended wing body aircraft” is an aircraft having a blended wing body. In one or more embodiments, blended wing body aircraft 100 (also referred to as an “aircraft” in this disclosure) may include various types of blended wing aircraft. For instance, and without limitation, aircraft 100 may include a special purpose aircraft. For the purposes of this disclosure, a “special purpose aircraft” is an aircraft used for a particular, designated purpose. A special aircraft may include a military or civilian aircraft having a particular role, such as a freighter, tanker, and the like, as discussed further in this disclosure. For example, and without limitation, blended wing body aircraft 100 may include a freighter aircraft, such as freighter 300 shown in FIG. 3. In another example, and without limitation, blended wing body aircraft 100 may include a tanker aircraft, such as tanker 400 shown in FIG. 4. Blended wing body aircraft 100 may include a blended wing body 108. As used in this disclosure, A “blended wing body” (also referred to as a “BWB”, a “blended body”, or a “hybrid wing body” (HWB) in this disclosure), is a fixed-wing aircraft body having no striking demarcation between wings and a main body of the aircraft along a leading edge of the aircraft.

With continued reference to FIG. 1A, BWB 108 may include two wings 116. As used in this disclosure, “wings” are components of an aircraft configured to generate lift as a function of dynamic pressure and angle of attack. Each wing may be distally located laterally on aircraft 100 such that, for example, a most distal part of each wing 116 may represent a most distal part of aircraft 100. In one or more embodiments, aircraft 100 and/or blended wing body 108 may include two transitions. As used in this disclosure, a “transition” of a blended wing body is a portion of a blended wing body between wing and main body.

With continued reference to FIG. 1A, BWB 108 may include one or more structural components 124 of aircraft 100 and/or of an airframe of aircraft 100. Structural components 124 may be used to construct and define an airframe of aircraft 100. Structural components 124 may provide physical stability during an entirety of an aircraft’s flight envelope, while on ground, and during normal operation. Structural components 124 may include, but are not limited to, struts, beams, formers, stringers, stiffeners, ribs, longerons, interstitials, ribs, (structural) skin, doublers, straps, spars, or panels, and the like. In various embodiments, structural components 124 may also include pillars. In some cases, for the purpose of aircraft cockpits having windows/windshields (e.g., windshields 216 shown in FIG. 2), pillars may include vertical or near vertical supports around a window configured to provide extra stability around weak points in a structure of aircraft 100, such as an opening where a window is installed. Where multiple pillars are disposed in a structure, or airframe of aircraft 100, pillars may be so named A, B, C, and so on named from nose to tail. Pillars, like any structural element, may be disposed a distance away from each other, along an exterior of BWB 108. Depending on manufacturing methods of BWB 108, pillars may be integral to an airframe and/or skin of aircraft, composed entirely of internal framing, or alternatively, may be only integral to structural skin elements. Structural skin will be discussed in greater detail below.

With continued reference to FIG. 1A, BWB 108 may include a plurality of materials, alone or in combination, in its construction. At least a BWB 108, in an illustrative embodiment may include a welded steel tube frame further configured to form a general shape of a nose corresponding to an arrangement of steel tubes. Steel may include any of a plurality of alloyed metals, including but not limited to, a varying amount of manganese, nickel, copper, molybdenum, silicon, and/or aluminum, to name a few. Welded steel tubes may be covered in any of a plurality of materials suitable for aircraft skin. Some of these may include carbon fiber, fiberglass panels, cloth-like materials, aluminum sheeting, or the like. BWB 108 may include aluminum tubing mechanically connected or coupled in various orientations. Mechanical fastening of aluminum members (whether pure aluminum or alloys) may include temporary or permanent mechanical fasteners appreciable by one of ordinary skill in the art including, but not limited to, screws, nuts and bolts, anchors, clips, welding, brazing, crimping, nails, blind rivets, pull-through rivets, pins, dowels, snap-fits, clamps, and the like. BWB 108 may, additionally or alternatively, use wood or another suitably strong yet light material for an internal structure or structural components.

With continued reference to FIG. 1A, aircraft 100 may include a monocoque or semi-monocoque construction. In various embodiments, one or more components, such as structural components 124, of BWB 108 may be composed of carbon fiber. Carbon fiber may include carbon fiber reinforced polymer, carbon fiber reinforced plastic, or carbon fiber reinforced thermoplastic (e.g., CFRP, CRP, CFRTP, carbon composite, or just carbon, depending on industry). “Carbon fiber,” as used in this disclosure, is a composite material including a polymer reinforced with carbon. In some cases, carbon fiber is beneficial, because of high compressive strength. Where high compressive strength is not needed, in some cases, other high strength fibers may be used. Exemplary high strength fibers include without limitation aramid (i.e. Kevlar), Technora, and Spectra. In general, carbon fiber composites consist of two parts, a matrix and a reinforcement. In carbon fiber reinforced plastic, the carbon fiber constitutes the reinforcement, which provides strength. The matrix can include a polymer resin, such as epoxy, to bind reinforcements together. Such reinforcement achieves an increase in CFRP’s strength and rigidity, measured by stress and elastic modulus, respectively. In embodiments, carbon fibers themselves can each comprise a diameter between 5-10 micrometers and include a high percentage (e.g., above 85%) of carbon atoms. A person of ordinary skill in the art will appreciate that the advantages of carbon fibers include high stiffness, high tensile strength, low weight, high chemical resistance, high temperature tolerance, and low thermal expansion. According to one or more embodiments, carbon fibers may be combined with other materials to form a composite where, when permeated with plastic resin and baked, carbon fiber reinforced polymer becomes extremely rigid. Rigidity may be considered analogous to stiffness which may be measured using Young’s Modulus. Rigidity may be defined as a force necessary to bend and/or flex a material and/or structure to a given degree. For example, and without limitation, ceramics have high rigidity, which can be visualized by shattering before bending. In embodiments, carbon fibers may additionally, or alternatively, be composited with other materials like graphite to form reinforced carbon-carbon composites, which include high heat tolerances over 2000^{o}C. A person of skill in the art will further appreciate that aerospace applications may require high-strength, low-weight, high heat resistance materials in a plurality of roles, such as, and without limitation, fuselages, fairings, control surfaces, and structures, among others. BWB 108 may be configured to contain pressure and resist cabin de-pressurization.

With continued reference to FIG. 1A, aircraft 100 may include a main body 112. Main body 112 may be centrally located laterally within aircraft 100, for example substantially between two wings. As used in this disclosure, a “main body” or “centerbody” is a centrally located portion of aircraft. In some cases, main body, unlike wings and/or transitions, has an associated lift coefficient with a minimal value. In some embodiments, aircraft 100 may have a lift distribution across a span that is approximately elliptical. In some cases, lift distribution may be understood of as a two-dimensional distribution where an x-axis represents span station laterally across aircraft, from tip to tip and a y-axis represents total lift per unit span (for example, in pounds per inch of span). In some cases, total lift per unit span may be a function of a product of a local wing chord and a local wing lift coefficient. As main body 112 will typically have a long local chord length, in some cases, a designer will minimize local lift coefficient at main body 112 to ensure an elliptical lift distribution. Lift coefficient of main body 112 may be minimized by adjusting main body incidence (relative to the transitions and outboard wings) and by adjusting the camber of main body 112 (e.g., to a low value, typically).

With continued reference to FIG. 1A, main body 112 may include a fuselage 128. A “fuselage,” for the purposes of this disclosure, refers to a main body of aircraft 100 except for nose, wings, empennage, nacelles, and control surfaces. In some cases, fuselage 128 may contain a payload of an aircraft, such as in the case of a freighter (e.g., freighter 300 shown in FIG. 3). Fuselage 128 may include structural components 124, as previously mentioned in this disclosure, that physically support a shape and structure of aircraft 100. Structural components 124 may take a plurality of forms, alone or in combination with other types, and arrangements. Structural components 124 vary depending on construction type of aircraft 100 and specifically, fuselage 128. In some embodiments, fuselage 128 may include a truss structure. A truss structure may be used with a lightweight aircraft. A truss structure may include welded steel tube trusses. A “truss,” as used in this disclosure, is an assembly of beams that create a rigid structure. For example, and without limitation, a truss may include combinations of triangles to create three-dimensional shapes. A truss structure may include wood construction in place of steel tubes, or a combination thereof. In some embodiments, structural components 124 can comprise steel tubes and/or wood beams. An structural skin (also referred to in this disclosure as a “skin”), such as skin 196, may be layered over a body shape constructed by trusses. Skin 196 may include a plurality of materials such as plywood sheets, aluminum, fiberglass, carbon fiber, any combination thereof, and the like. In one or more embodiments, fuselage 128 may include an interior cavity 136, as discussed further in FIG. 1B and FIG. 3.

With continued reference to FIG. 1A, in embodiments, fuselage 128 may include geodesic construction. Geodesic structural elements may include stringers wound about formers, which may be alternatively called station frames, in opposing spiral directions. A “stringer,” for the purposes of this disclosure is a general structural element that includes a long, thin, and rigid strip of metal or wood that is mechanically coupled to and spans the distance from, station frame to station frame to create an internal skeleton on which to mechanically couple aircraft skin. A former (or station frame) can include a rigid structural element that is disposed along a length of an interior of a fuselage orthogonal to a longitudinal (nose to tail) axis (i.e. longitudinal axis A, shown in FIG. 1B) of aircraft 100. In some cases, a former forms a general shape of fuselage 128. A former may include differing cross-sectional shapes at differing locations along a fuselage, as the former is a structural component that informs an overall shape of the fuselage. In embodiments, skin 196 may be anchored to formers and stringers such that an outer mold line (OML) of volume encapsulated by the formers and stringers comprises a same shape as aircraft 100 when installed. In other words, former(s) may form a fuselage’s rib(s), and stringers may form interstitials between the ribs. A spiral orientation of stringers about formers may provide uniform robustness at any point on an aircraft fuselage such that if a portion sustains damage, another portion may remain largely unaffected. Skin 196 may be mechanically connected or coupled to underlying stringers and formers and may interact with a fluid, such as air, to generate lift and perform maneuvers.

With continued reference to FIG. 1A, according to some embodiments, fuselage 128 may include a monocoque construction. Monocoque construction may include a primary structure that forms a shell (e.g., skin 196) and supports physical loads. Monocoque fuselages are fuselages in which the aircraft skin or shell may also include a primary structure. In monocoque construction, aircraft skin would support tensile and compressive loads within itself and true monocoque aircraft can be further characterized by an absence of internal structural elements. Skin 196 in this construction method may be rigid and can sustain its shape with substantially no structural assistance form underlying skeleton-like elements. Monocoque fuselage may include aircraft skin made from plywood layered in varying grain directions, epoxy-impregnated fiberglass, carbon fiber, or any combination thereof.

With continued reference to FIG. 1A, according to some embodiments, fuselage 128 may include a semi-monocoque construction. Semi-monocoque construction, as used in this disclosure, is used interchangeably with partially monocoque construction, as discussed above. In semi-monocoque construction, fuselage 128 may derive some structural support from stressed skin and some structural support from underlying frame structure made of structural components (e.g., 124). Formers or station frames can be seen running transverse to longitudinal axis A of fuselage with circular cutouts which may be used in real-world manufacturing for weight savings and for routing of electrical harnesses and other modern on-board systems. In a semi-monocoque construction, stringers may be thin, long strips of material that run parallel to a fuselage’s long axis. Stringers can be mechanically connected or coupled to formers permanently, such as with rivets. Skin can be mechanically connected or coupled to stringers and formers permanently, such as by rivets as well. A person of ordinary skill in the art will appreciate that there are numerous methods for mechanical fastening of the aforementioned components like screws, nails, dowels, pins, anchors, adhesives like glue or epoxy, or bolts and nuts, to name a few. According to some embodiments, a subset of semi-monocoque construction may be unibody construction. Unibody, which is short for “unitized body”, or alternatively “unitary construction”, vehicle are characterized by a construction in which body, floor plan, and chassis form a single structure, such as, for example, an automobile. In the aircraft world, a unibody may include internal structural elements, like formers and stringers, constructed in one piece, integral to skin 196. In some cases, stringers and formers may account for a bulk of any aircraft structure, excluding monocoque construction. Stringers and formers may be arranged in a plurality of orientations depending on aircraft operation and materials. Stringers may be arranged to carry axial (tensile or compressive), shear, bending, or torsion forces throughout their overall structure. Due to their coupling to skin, aerodynamic forces exerted on skin may be transferred to stringers. Location of such stringers greatly informs type of forces and loads applied to each and every stringer, all of which may be accounted for through design processes including, material selection, cross-sectional area, and mechanical coupling methods of each member. Similar methods may be performed for former assessment and design. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination.

With continued reference to FIG. 1A, in some cases, a primary purpose for a substructure of a semi-monocoque structure is to stabilize skin 196. Typically, an aircraft structure is required to have a very light weight and, as a result, in some cases, skin 196 may be substantially thin. In some cases, unless supported, a thin skin structure may tend to buckle and/or cripple under compressive and/or shear loads. In some cases, underlying structure may be primarily configured to stabilize skin 196, which may include one or more skins. For example, and without limitation, in an exemplary conventional airliner, wing structure is an airfoil-shaped box with truncated nose and aft triangle; without stabilizing substructure, in some cases, this box would buckle upper skin of the wing and the upper skin would also collapse into the lower skin under bending loads. In some cases, deformations are prevented with ribs that support stringers which stabilize the skin. Fuselages are similar with bulkheads or frames, and stringers.

With continued reference to FIG. 1A, in some embodiments, another common structural form is a sandwich structure. As used in this disclosure, a “sandwich structure” is a skin structure having an inner and outer skin separated and stabilized by a core material. In some cases, sandwich structure may additionally include some number of ribs or frames. In some cases, sandwich structure may include metal, polymer, and/or composite. In some cases, core material may include honeycomb, foam plastic, and/or end-grain balsa wood. In some cases, sandwich structure can be popular on composite light airplanes, such as gliders and powered light planes. In some cases, sandwich structure may not use stringers, and sandwich structure may allow number of ribs or frames to be reduced, for instance in comparison with a semi-monocoque structure. In some cases, sandwich structure may be suitable for smaller, possibly unmanned, unpressurized blended wing body aircraft.

With continued reference to FIG. 1A, stressed skin, when used in semi-monocoque construction, may bear partial, yet significant, load. In other words, an internal structure, whether it be a frame of welded tubes, formers and stringers, or some combination, is not sufficiently strong enough by design to bear all loads. The concept of stressed skin is applied in monocoque and semi-monocoque construction methods of fuselage 128 and/or BWB 108. In some cases, monocoque may be considered to include substantially only structural skin, and in that sense, aircraft skin undergoes stress by applied aerodynamic fluids imparted by fluid. Stress as used in continuum mechanics can be described in pound-force per square inch (lbf/in²) or Pascals (Pa). In semi-monocoque construction stressed skin bears part of aerodynamic loads and additionally imparts force on an underlying structure of stringers and formers.

Now referring to FIG. 1B, fuselage 128 may include an interior cavity 136. For the purposes of this disclosure, an “interior cavity” is a space disposed within a fuselage of an aircraft and defined by the airframe of the aircraft. For instance, and without limitation, interior cavity 136 may be defined by an interior surface of fuselage 128. Interior cavity may be defined by at least a height h, a length l, and a width w, as shown in FIG. 1B. As understood by one of ordinary skill in the art, height h, length l, and width w may vary along a cross section of interior cavity based on a shape of interior cavity, as discussed further below. In some embodiments, interior cavity 136 may include one or more cabins, decks, holds, bays, cubicles, any combination thereof, and the like. For instance, and without limitation, interior cavity 136 may include a single volumetric space or region configurable to house any payload, including cargo 114, passengers, and fuel. In another instance, and without limitation, interior cavity 136 may be compartmentalized to include a plurality of volumetric spaces disposed within interior cavity 136. Such compartmentalized spaces may be used for the same purpose of various purposes, such as cargo 114, passenger, fuel, or equipment storage. For the purposes of this disclosure, “payload” the part of a vehicle’s load which is being purposely transported, for instance the part of a vehicle’s load from which revenues are being derived. For the purposes of this disclosure, “cargo” is goods that are moved from one location to another via transportation. Cargo 114 may include container cargo, dry bulk cargo, liquid bulk cargo, break bulk cargo, neo bulk cargo, roll-on roll-off (RO RO) cargo, and the like. Payload may include solids, liquids, persons (e.g., military personnel, medical personnel, commercial passengers, or any other types of passengers aboard aircraft), and the like. Interior cavity 136 may be configured to include receptacles for fuel tanks, batteries, fuel cells, or other energy sources. In some cases, interior cavity 136 may include a base 110 of airframe, which one or more structural components 124 may be attached thereto. Base 110 may include a deck, or floor, that cargo may be placed on during transportation (e.g., operation or movement of aircraft 100). In some embodiments, interior cavity 136 may include a post may be supporting a floor, or in other words a surface on which a passenger, operator, passenger, payload, or other object would rest on due to gravity when within an aircraft 100 is in its level flight orientation or sitting on ground (e.g., parked or taxing). A post may act similarly to stringer in that it is configured to support axial loads in compression due to a load being applied parallel to its axis due to, for example, a heavy object being placed on a floor of aircraft 100. A beam may be disposed in or on any portion of fuselage that requires additional bracing, specifically when disposed transverse to another structural component, like a post, which would benefit from support in that direction, opposing applied force. A beam may be disposed in a plurality of locations and orientations within a fuselage as necessitated by operational and constructional requirements.

Referring back to FIG. 1A, aircraft 100 includes a passenger compartment 104 that is configured to seat one or more passengers of blended wing body aircraft 100. A passenger may include any persons, such as aircraft personnel (e.g.,pilots or crew), commercial passengers, military personnel, and the like. For instance, and without limitation, passenger compartment 104 may be used by flight crew of aircraft to reside when not assisting other passengers on the plan located elsewhere, such as in the main cabin of the fuselage of the aircraft. In some cases, passenger compartment 104 may be used by flight crew when resting for, or during, long flights. In one or more embodiments, passenger compartment 104 may include an upper passenger compartment. For the purposes of this disclosure, an “upper passenger compartment” is a passenger compartment located within an upper portion 140 of a fuselage 128 of an aircraft 100. For instance, and without limitation, upper passenger compartment may be located in an upper portion 140 (e.g., an upper fraction, such as an upper half) of fuselage 128. In some embodiments, upper passenger compartment may be located in an upper portion 140 of interior cavity 136 of fuselage 128. For example, and without limitation, upper passenger compartment may be positioned above cargo 114, which is disposed in interior cavity 136 of fuselage 128, as shown in FIG. 1B. Passenger compartment 104 may include a defined area positioned above a deck or base of aircraft 100 (shown in FIG. 1B). In one or more embodiments, a volume of aircraft 100 may be altered to provide passenger accommodations, such as by reshaping an outer-mold-line (OML) of aircraft 100, but still maintaining aerodynamics of aircraft 100. In other embodiments, passenger compartment 104 may be disposed within BWB 108 without altering the OML of aircraft 100 and while still maintaining favorable aerodynamic shaping of aircraft 100. At the same time, the BWB design of aircraft may provide storage space dimensions (i.e. width, length, and height) that effectively fit dimensions of various types of cargo and/or cargo containers. Furthermore, passenger compartment dimensions may allow for favorable passenger provisions in terms of cabin width, ceiling height, doors, aisles, and the like. In one or more embodiments, BWB 108 may include a large cargo door (e.g., loading door 132) and/or one or more structural openings to permit various sized containers to enter and fill interior cavity 136 of aircraft 100. In one or more embodiments, at least a lower portion 144 of fuselage 128 may include a cargo bay. In nonlimiting exemplary embodiments, cargo bay may be filled with cargo 114, such as, for example and without limitation, M1 containers as discussed further below in FIG. 3.

Referring back to FIG. 1B, blended wing body 108 may include a lower portion 144 and an upper portion 140, as previously mentioned above in this disclosure. For the purposes of this disclosure, a “lower portion” is a region of a fuselage that is below the upper portion of the fuselage. In various embodiments, lower portion 144 may include an underside of fuselage 128. In some embodiments, lower portion 144 may include base 110. For the purposes of this disclosure, an “upper portion” is a region of a fuselage above a lower portion of the fuselage. In various embodiments, upper portion 140 may include a top side of fuselage 128. In one or more nonlimiting embodiments, upper portion 140 may include upper half of fuselage 128. For example, and without limitation, upper portion 140 may include a portion above longitudinal axis A and lower portion 144 may include a portion below longitudinal axis A. In one or more embodiments, lower portion 144 may be configured to store one or more objects or materials, such as cargo 320 of FIG. 3, or fuel, such as a fuel store of FIG. 4, to name a few. In some embodiments, passenger compartment 104 may be positioned in a front half 148 of fuselage 128. A front portion 148 of fuselage 128 may include a region of fuselage that is forward of a central axis B (i.e.an axis orthogonal to longitudinal axis A) and a rear portion of fuselage 128. For instance, and without limitation, front portion 148 may include a region of fuselage 128 that includes half of fuselage 128 from central axis B to a cockpit bulkhead 122. In other embodiments, passenger compartment 104 may extend from front half 148 to a rear portion 102. In one or more nonlimiting embodiments, and without limitation, the blended wing body 108 may include nose portion, such as nose portion 208 in FIG. 2, which may include a cockpit. For the purpose of this disclosure, a “cockpit” is a compartment of an aircraft for a pilot or crew members which includes systems used for operation of the aircraft. Passenger compartment 104 may be positioned adjacent (e.g., aft) to cockpit or within nose portion of aircraft 100. In other embodiments, passenger compartment 104 may be positioned in a rear half 152 of interior cavity 136. In one or more embodiments, passenger compartment 104 may include a pax compartment, which may be positioned above cargo, such as above lower portion 144. In one or more embodiments, cockpit fairing can house a height of BWB OML to accommodate passengers and cargo. Because of airframe design of aircraft 100, a height of BWB OML may be used to accommodate passengers above the main cargo region/deck where height is sufficient. In some embodiments, passenger compartment 104 may be positioned toward the front of aircraft 100, as shown in FIG. 1B. In other embodiments, passenger compartment 104 may be disposed in a center of interior cavity 136 or located at the center of a cargo bay of aircraft 100. Passenger compartment 104 may include a partial deck, where partial deck may be located at least partially above a cargo bay and/or a first fuel store within a main body 112 of blended wing body 108. For the purposes of this disclosure, a “partial deck” is an area that does not extend the entire length of a fuselage of an aircraft. For instance, and without limitation, passenger compartment may not extend the entire length of a cargo bay of aircraft 100. For example, and without limitations, passenger compartment 104 may extend only a portion of interior cavity. More specifically, and in nonlimiting embodiments, length Lof passenger compartment 104 may be less than length l of fuselage 128. In some cases, passenger compartment 104 may be located behind a cockpit (e.g.,in a nose portion of blended wing body).

Still referring to FIG. 1B, in one or more embodiments, lower portion of interior cavity may have a greater floor area than upper portion of interior cavity. “Floor area,” for the purposes of this disclosure, is area of floor in a specified area.

Still referring to FIG. 1B, in one or more embodiments, passenger compartment 104 may be positioned in upper portion 140 of blended wing body 108. In one or more embodiments, passenger compartment 104 may include one or more walls 160. In various embodiments, walls 160 may include outer walls that define an outer perimeter of passenger compartment 104. In various embodiments, walls 160 may include inner walls, such as a partitioning wall 172 of passenger compartment 104. In some embodiments, one or more walls 160 may be constructed using one or more structural components 124. For instance, and without limitation, wall 160 may include at least a portion of a longitudinal stiffener, as shown in FIG. 1A. In one or more embodiments, passenger compartment 104 may include a floor 164, where floor 164 may adjoin one or more walls 160. Walls 160 and adjoined floor 164 may provide an enclosure of passenger compartment 104 that is configured to hold one or more passengers. For the purposes of this disclosure, a “floor” is a supporting surface of a passenger compartment. For example, and without limitation, a floor may include a surface that a person may stand on or that furniture may be placed upon. In one or more embodiments, passenger compartment 104 may include various seating arrangements.

Still referring to FIG. 1B, passenger compartment 104 may include a compartmentalized cabin, where passenger compartment may be divided into one or more areas (e.g., rooms or sections at least partially delineated from each other). Passenger compartment 104 may include one or more seats may be disposed within the cabin. For example, and without limitation, passenger compartment 104 may include a sitting area 156 that includes one or more seats disposed therein. In one or more embodiments, passenger compartment 104 may include internal dimensions having a height H,width W, and length L. Height H of passenger compartment 104 may include a distance from floor 164 to a ceiling 126 of passenger compartment 104. In some embodiments, height H of passenger compartment 104 may be reduced compared to conventional cabin height for commercial airlines, but still allow for ample headspace for passengers, such as passenger 134. In various nonlimiting embodiments, a cabin height H of passenger compartment 104 may include a ceiling height of less than 3 meters. Passenger compartment 104 may include a sitting area 156. For the purposes of this disclosure, a “sitting area” is a room or space designated for personnel seating during a flight of an aircraft. Sitting area 156 may include one or more seats 168. Each seat 168 may include a safety mechanism for securing a passenger sitting in the corresponding seat during operation of aircraft 100. For example, and without limitation, a safety mechanism may include a sash, strap. or lap belt. Safety mechanism may also include a fastening mechanism, such as a buckle and tongue that may engage to secure a passenger in seat 168. Seatbelt may be configured to secure a passenger during operation of aircraft 100. In nonlimiting embodiments, seat 168 may include a chair, such as a reclining chair, an armchair, a bench, a stool, foldable chair, any combination thereof or the like. In some embodiments, seat 168 may be integrated into sitting area 156. In other embodiments, seat 168 may be an individual or separate piece of furniture that may be assembled or moved into sitting area 156. In one or more embodiments, passenger compartment 104 may also include a sleeping area 176. For the purposes of this disclosure, a “sleeping area” is a space or room designated for personnel to rest during a flight of an aircraft. Sleeping area 176 may include one or more bunks 188. A “bunk”, for the purposes of this disclosure, is a piece of furniture used for sleeping or resting. A bunk may include, for example and without limitation, a bed or other furniture that a passenger may rest on. In some embodiments, bunk 188 may be integrated into one or more walls of sleeping area 176. In other embodiments, bunk 188 may be a separate piece of, for example, assembled or movable furniture. For example, and without limitation, bunk 188 may include a cot, bunk (stacked) beds, a single bed, a daybed, a foldable bed, a murphy bed, a bench, a chaise lounge, a sofa, a fully or partially enclosed pod, any combination thereof, and the like. In one or more embodiments, passenger compartment 104 may include a partitioning wall 172 configured to at least partially physically divide sitting area 156 and sleeping area 176. In one or more embodiments, partitioning wall 172 may include an opening, such as a doorway 192, that allows for a passenger to traverse from one area to another of passenger compartment 104. In some embodiments, doorway 192 may also include a port disposed in floor 164 of passenger compartment 104, where a passenger 134 may descend/ascend from/into passenger compartment 104 via, for example, a ladder or stairs. In one or more embodiments, one or more walls 160 of passenger compartment 104 may include insulated walls. Insulated walls may be insulated to regulate a temperature, noise, and/or pressure of a cabin or one or more areas (e.g., sitting area or sleeping area) of passenger compartment 104. In one or more embodiments, one of the one or more walls 160 may include a structural component, such as a stiffener. For example, and without limitation, adjacent pair of longitudinal stiffeners 184 may define a pair of opposing walls of passenger compartment 104. In one or more embodiments, passenger compartment 104 may luggage storage 180. In some embodiments, luggage storage 180 may include overhead luggage storage for passengers. In various embodiments, luggage storage 180 may include cabinets, containers, racks, enclosure, cubbyhole, any combination thereof, and the like. In various embodiments, passenger compartment 104 may also include a galley. In various embodiments, passenger compartment 104 may also include a lavatory.

Now referring to FIG. 2, a perspective view of an exemplary embodiment of aircraft 100 with a passenger compartment 104 is shown. In one or more embodiments, aircraft 100 may include a propulsion system 204. As used in this disclosure, a “propulsion system” is any system or device configured to generate thrust in a fluid medium. For example, a propulsion system 204 may include a propulsor (e.g., fan, propellor, rotor, and the like). In some cases, a propulsion system 204 may include one or more of an engine (e.g., jet engine) and a motor (e.g., electric motor). Propulsion system 204 may include any propulsion system, propulsor, engine, or motor described in this disclosure. In one or more embodiments, propulsion system 204 may include an engine fueled by one or more of first fuel and second fuel. Alternatively or additionally, in some embodiments, propulsion system 204 may include a motor powered by electricity. In some cases. electricity may be derived from one or more of first fuel and second fuel. For example, in some cases, electricity may be generated from one or more of a generator, alternator or the like. Alternatively or additionally, in some cases, electricity may be produced by a fuel cell.

Still referring to FIG. 2, in some embodiments, propulsion system 204 may include an electric motor. Electric motor may be powered by one or more electricity sources, such as without limitation batteries and/or fuel cells. Additional disclosure related to fuel cell technology may be found in U.S. Pat. App. No. 17/ 478,724 title “BLENDED WING BODY AIRCRAFT WITH A FUEL CELL AND METHOD OF USE,” filed on September 17, 2021, and incorporated by reference, in its entirety, within this disclosure. In some cases, a fuel cell may provide steady state power for to propulsion system 204, for example for cruise flight. Alternatively or additionally, a battery or another electricity source may provide supplemental power for climbing. In some cases, fuel cell may be configured to charge battery or another electricity source, when it produces excess power, for example during descent or ground operations. In one or more embodiments, propulsion system 204 may include at least a propulsor mechanically affixed to the aircraft 100. In some cases, at least a propulsor may be configured to propel aircraft 100. In some embodiments, at least a propulsor may include at least a combustion engine that burns one or more of first fuel and second fuel and produces mechanical work. Resulting mechanical work may be used to power at least a propulsor. In some embodiments, at least a propulsor may include at least an electric motor operatively connected with fuel cell. Alternatively or additionally, propulsor may be powered by one or more batteries. Batteries may include any batteries described in this disclosure. Propulsor may be operatively connected to fuel cell by way of electrical communication, for example through one or more conductors. In some cases, at least a fuel cell may be configured to power at least an electric motor of propulsor. In some embodiments, at least a propulsor may include both a combustion engine and an electric motor.

With continued reference to FIG. 2, aircraft 100 may include one or more flight components 212. Flight component 212 may be consistent with any description of a flight component described in this disclosure, such as without limitation propulsors, control surfaces, rotors, paddle wheels, engines, propellers, wings, winglets, or the like. For the purposes of this disclosure, at least a “flight component” is at least one element of an aircraft 100 configured to manipulate a fluid medium such as air to propel, control, or maneuver an aircraft. In nonlimiting examples, at least a flight component may include a rotor mechanically connected to a rotor shaft of an electric motor further mechanically affixed to at least a portion of aircraft 100. In some embodiments, at least a flight component 212 may include a propulsor, for example a rotor attached to an electric motor configured to produce shaft torque and in turn, create thrust. As used in this disclosure, an “electric motor” is an electrical machine that converts electric energy into mechanical work. For the purposes of this disclosure, “torque”, is a twisting force that tends to cause rotation. Torque may be considered an effort and a rotational analogue to linear force. A magnitude of torque of a rigid body may depend on three quantities: a force applied, a lever arm vector connecting a point about which the torque is being measured to a point of force application, and an angle between the force and the lever arm vector. A force applied perpendicularly to a lever multiplied by its distance from the lever's fulcrum (the length of the lever arm) is its torque. A force of three newtons applied two meters from the fulcrum, for example, exerts the same torque as a force of one newton applied six meters from the fulcrum. In some cases, direction of a torque can be determined by using a right-hand grip rule which states: if fingers of right hand are curled from a direction of lever arm to direction of force, then thumb points in a direction of the torque. One of ordinary skill in the art would appreciate that torque may be represented as a vector, consistent with this disclosure, and therefore may include a magnitude and a direction. “Torque” and “moment” are used interchangeably within this disclosure. Any torque command or signal within this disclosure may include at least the steady state torque to achieve the torque output to at least a propulsor.

With continued reference to FIG. 2, flight component 212 may be one or more devices configured to affect an attitude of aircraft 100. “Attitude”, for the purposes of this disclosure, is the relative orientation of a body, in this case aircraft 100, as compared to earth’s surface or any other reference point and/or coordinate system. In some cases, attitude may be displayed to pilots, personnel, remote users, or one or more computing devices in an attitude indicator, such as without limitation a visual representation of a horizon and its relative orientation to aircraft 100. A plurality of attitude datums may indicate one or more measurements relative to an aircraft’s pitch, roll, yaw, or throttle compared to a relative starting point. One or more sensors may measure or detect an aircraft’s 400 attitude and establish one or more attitude datums. An “attitude datum”, for the purposes of this disclosure, refers to at least an element of data identifying an attitude of an aircraft 100.

With continued reference to FIG. 2, at least a flight component 212 may include wings, empennages, nacelles, control surfaces, fuselages, and landing gear, among others, to name a few. In embodiments, an empennage may be disposed at the aftmost point of an aircraft body 404. Empennage may comprise a tail of aircraft 100, further comprising rudders, vertical stabilizers, horizontal stabilizers, stabilators, elevators, trim tabs, among others. At least a portion of empennage may be manipulated directly or indirectly by pilot commands to impart control forces on a fluid in which the aircraft 100 is flying. Manipulation of these empennage control surfaces may, in part, change an aircraft’s heading in pitch, roll, and yaw. Wings comprise may include structures which include airfoils configured to create a pressure differential resulting in lift. Wings are generally disposed on a left and right side of aircraft 100 symmetrically, at a point between nose and empennage. Wings may comprise a plurality of geometries in planform view, swept swing, tapered, variable wing, triangular, oblong, elliptical, square, among others. Wings may be blended into the body of the aircraft such as in a BWB 108 aircraft 100 where no strong delineation of body and wing exists. A wing’s cross section geometry may comprise an airfoil. An “airfoil” as used in this disclosure, is a shape specifically designed such that a fluid flowing on opposing sides of it exert differing levels of pressure against the airfoil. In embodiments, a bottom surface of an aircraft can be configured to generate a greater pressure than does a top surface, resulting in lift. A wing may comprise differing and/or similar cross-sectional geometries over its cord length, e.g. length from wing tip to where wing meets the aircraft’s body. One or more wings may be symmetrical about an aircraft’s longitudinal plane, which comprises a longitudinal or roll axis reaching down a center of the aircraft through the nose and empennage, and the aircraft’s yaw axis. In some cases, wings may comprise controls surfaces configured to be commanded by a pilot and/or autopilot to change a wing’s geometry and therefore its interaction with a fluid medium. Flight component 212 may include control surfaces. Control surfaces may include without limitation flaps, ailerons, tabs, spoilers, and slats, among others. In some cases, control surfaces may be disposed on wings in a plurality of locations and arrangements. In some cases, control surfaces may be disposed at leading and/or trailing edges of wings, and may be configured to deflect up, down, forward, aft, or any combination thereof.

In some cases, flight component 212 may include a winglet. For the purposes of this disclosure, a “winglet” is a flight component configured to manipulate a fluid medium and is mechanically attached to a wing or aircraft and may alternatively called a “wingtip device.” Wingtip devices may be used to improve efficiency of fixed-wing aircraft by reducing drag. Although there are several types of wingtip devices which function in different manners, their intended effect may be to reduce an aircraft's drag by partial recovery of tip vortex energy. Wingtip devices can also improve aircraft handling characteristics and enhance safety for aircraft 100. Such devices increase an effective aspect ratio of a wing without greatly increasing wingspan. Extending wingspan may lower lift-induced drag but would increase parasitic drag and would require boosting the strength and weight of the wing. As a result according to some aeronautic design equations, a maximum wingspan made be determined above which no net benefit exits from further increased span. There may also be operational considerations that limit the allowable wingspan (e.g., available width at airport gates).

Wingtip devices, in some cases, may increase lift generated at wingtip (by smoothing airflow across an upper wing near the wingtip) and reduce lift-induced drag caused by wingtip vortices, thereby improving a lift-to-drag ratio. This increases fuel efficiency in powered aircraft and increases cross-country speed in gliders, in both cases increasing range. U.S. Air Force studies indicate that a given improvement in fuel efficiency correlates directly and causally with increase in an aircraft's lift-to-drag ratio. The term "winglet" has previously been used to describe an additional lifting surface on an aircraft, like a short section between wheels on fixed undercarriage. An upward angle (i.e., cant) of a winglet, its inward or outward angle (i.e., toe), as well as its size and shape are selectable design parameters which may be chosen for correct performance in a given application. A wingtip vortex, which rotates around from below a wing, strikes a cambered surface of a winglet, generating a force that angles inward and slightly forward. A winglet’s relation to a wingtip vortex may be considered analogous to sailboat sails when sailing to windward (i.e., close-hauled). Similar to the close-hauled sailboat’s sails, winglets may convert some of what would otherwise-be wasted energy in a wingtip vortex to an apparent thrust. This small contribution can be worthwhile over the aircraft's lifetime. Another potential benefit of winglets is that they may reduce an intensity of wake vortices. Wake vortices may trail behind an aircraft 100 and pose a hazard to other aircraft. Minimum spacing requirements between aircraft at airports are largely dictated by hazards, like those from wake vortices. Aircraft are classified by weight (e.g., "Light," "Heavy," and the like) often base upon vortex strength, which grows with an aircraft’s lift coefficient. Thus, associated turbulence is greatest at low speed and high weight, which may be produced at high angle of attack near airports. Winglets and wingtip fences may also increase efficiency by reducing vortex interference with laminar airflow near wingtips, by moving a confluence of low-pressure air (over wing) and high-pressure air (under wing) away from a surface of the wing. Wingtip vortices create turbulence, which may originate at a leading edge of a wingtip and propagate backwards and inboard. This turbulence may delaminate airflow over a small triangular section of an outboard wing, thereby frustrating lift in that area. A fence/winglet drives an area where a vortex forms upward away from a wing surface, as the resulting vortex is repositioned to a top tip of the winglet.

With continued reference to FIG. 2, aircraft 100 may include an energy source. Energy source may include any device providing energy to at least a flight component 212, for example at least a propulsors. Energy source may include, without limitation, a generator, a photovoltaic device, a fuel cell such as a hydrogen fuel cell, direct methanol fuel cell, and/or solid oxide fuel cell, or an electric energy storage device; electric energy storage device may include without limitation a battery, a capacitor, and/or inductor. The energy source and/or energy storage device may include at least a battery, battery cell, and/or a plurality of battery cells connected in series, in parallel, or in a combination of series and parallel connections such as series connections into modules that are connected in parallel with other like modules. Battery and/or battery cell may include, without limitation, Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode. In embodiments, the energy source may be used to provide electrical power to an electric or hybrid propulsor during moments requiring high rates of power output, including without limitation takeoff, landing, thermal de-icing and situations requiring greater power output for reasons of stability, such as high turbulence situations. In some cases, battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. A person of ordinary skill in the art, upon reviewing the entirety of this disclosure, will be aware of various devices of components that may be used as an energy source.

With continued reference to FIG. 2, in further nonlimiting embodiments, an energy source may include a fuel store. As described above a fuel store is an aircraft component configured to store a fuel. In some cases, a fuel store may include a fuel tank. Fuel may include a liquid fuel, a gaseous fluid, a solid fuel, and fluid fuel, a plasma fuel, and the like. As used in this disclosure, a “fuel” may include any substance that stores energy. Exemplary non-limiting fuels include hydrocarbon fuels, petroleum-based fuels., synthetic fuels, chemical fuels, Jet fuels (e.g., Jet-A fuel, Jet-B fuel, and the like), kerosene-based fuel, gasoline-based fuel, an electrochemical-based fuel (e.g., lithium-ion battery), a hydrogen-based fuel, natural gas-based fuel, and the like. As described in greater detail below fuel store may be located substantially within blended wing body 404 of aircraft 100, for example without limitation within a wing portion 412 of blended wing body 408. Aviation fuels may include petroleum-based fuels, or petroleum and synthetic fuel blends, used to power aircraft 100. In some cases, aviation fuels may have more stringent requirements than fuels used for ground use, such as heating and road transport. Aviation fuels may contain additives to enhance or maintain properties important to fuel performance or handling. Fuel may be kerosene-based (JP-8 and Jet A-1), for example for gas turbine-powered aircraft. Piston-engine aircraft may use gasoline-based fuels and/or kerosene-based fuels (for example for Diesel engines). In some cases, specific energy may be considered an important criterion in selecting fuel for an aircraft 100. Liquid fuel may include Jet-A. Presently Jet-A powers modern commercial airliners and is a mix of extremely refined kerosene and burns at temperatures at or above 49 °C (120 °F). Kerosene-based fuel has a much higher flash point than gasoline-based fuel, meaning that it requires significantly higher temperature to ignite.

With continued reference to FIG. 2, modular aircraft 100 may include an energy source which may include a fuel cell. As used in this disclosure, a “fuel cell” is an electrochemical device that combines a fuel and an oxidizing agent to create electricity. In some cases, fuel cells are different from most batteries in requiring a continuous source of fuel and oxygen (usually from air) to sustain the chemical reaction, whereas in a battery the chemical energy comes from metals and their ions or oxides that are commonly already present in the battery, except in flow batteries. Fuel cells can produce electricity continuously for as long as fuel and oxygen are supplied.

With continued reference to FIG. 2, in some embodiments, fuel cells may consist of different types. Commonly a fuel cell consists of an anode, a cathode, and an electrolyte that allows ions, often positively charged hydrogen ions (protons), to move between two sides of the fuel cell. At anode, a catalyst causes fuel to undergo oxidation reactions that generate ions (often positively charged hydrogen ions) and electrons. Ions move from anode to cathode through electrolyte. Concurrently, electrons may flow from anode to cathode through an external circuit, producing direct current electricity. At cathode, another catalyst causes ions, electrons, and oxygen to react, forming water and possibly other products. Fuel cells may be classified by type of electrolyte used and by difference in startup time ranging from 4 second for proton-exchange membrane fuel cells (PEM fuel cells, or PEMFC) to 10 minutes for solid oxide fuel cells (SOFC). In some cases, energy source may include a related technology, such as flow batteries. Within a flow battery fuel can be regenerated by recharging. Individual fuel cells produce relatively small electrical potentials, about 0.7 volts. Therefore, in some cases, fuel cells may be "stacked", or placed in series, to create sufficient voltage to meet an application's requirements. In addition to electricity, fuel cells may produce water, heat and, depending on the fuel source, very small amounts of nitrogen dioxide and other emissions. Energy efficiency of a fuel cell is generally between 40 and 90%.

Fuel cell may include an electrolyte. In some cases, electrolyte may define a type of fuel cell. Electrolyte may include any number of substances like potassium hydroxide, salt carbonates, and phosphoric acid. Commonly a fuel cell is fueled by hydrogen. Fuel cell may feature an anode catalyst, like fine platinum powder, which breaks down fuel into electrons and ions. Fuel cell may feature a cathode catalyst, often nickel, which converts ions into waste chemicals, with water being the most common type of waste. A fuel cell may include gas diffusion layers that are designed to resist oxidization.

With continued reference to FIG. 2, aircraft 100 may include an energy source which may include a cell such as a battery cell, or a plurality of battery cells making a battery module. An energy source may be a plurality of energy sources. The module may include batteries connected in parallel or in series or a plurality of modules connected either in series or in parallel designed to deliver both the power and energy requirements of the application. Connecting batteries in series may increase the voltage of an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of an energy source may be based on the individual battery cell performance or an extrapolation based on the measurement of at least an electrical parameter. In an embodiment where an energy source includes a plurality of battery cells, the overall power output capacity may be dependent on the electrical parameters of each individual cell. If one cell experiences high self-discharge during demand, power drawn from an energy source may be decreased to avoid damage to the weakest cell. An energy source may further include, without limitation, wiring, conduit, housing, cooling system and battery management system. Persons skilled in the art will be aware, after reviewing the entirety of this disclosure, of many different components of an energy source.

With continued reference to FIG. 2, aircraft 100 may include multiple flight component sub-systems, each of which may have a separate energy source. For instance, and without limitation, one or more flight components 408 may have a dedicated energy source. Alternatively, or additionally, a plurality of energy sources may each provide power to two or more flight components 212, such as, without limitation, a “fore” energy source providing power to flight components located toward a front of an aircraft 100, while an “aft” energy source provides power to flight components located toward a rear of the aircraft 100. As a further non-limiting example, a flight component of group of flight components may be powered by a plurality of energy sources. For example, and without limitation, two or more energy sources may power one or more flight components; two energy sources may include, without limitation, at least a first energy source having high specific energy density and at least a second energy source having high specific power density, which may be selectively deployed as required for higher-power and lower-power needs. Alternatively, or additionally, a plurality of energy sources may be placed in parallel to provide power to the same single propulsor or plurality of propulsors 408. Alternatively, or additionally, two or more separate propulsion subsystems may be joined using intertie switches (not shown) causing the two or more separate propulsion subsystems to be treatable as a single propulsion subsystem or system, for which potential under load of combined energy sources may be used as the electric potential. Persons skilled in the art, upon reviewing the entirety of this disclosure, will be aware of various combinations of energy sources that may each provide power to single or multiple propulsors in various configurations.

With continued reference to FIG. 2, aircraft 100 may include a flight component 212. In various embodiments, flight component 212 may include a nacelle. For the purposes of this disclosure, a “nacelle” is a streamlined body housing, which is sized according to that which is houses, such as without limitation an engine, a fuel store, or a flight component. When attached by a pylon entirely outside an airframe a nacelle may sometimes be referred to as a pod, in which case an engine within the nacelle may be referred to as a podded engine. In some cases an aircraft cockpit may also be housed in a nacelle, rather than in a conventional fuselage. At least a nacelle may substantially encapsulate a propulsor, which may include a motor or an engine. At least a nacelle may be mechanically connected to at least a portion of aircraft 100 partially or wholly enveloped by an outer mold line of the aircraft 100. At least a nacelle may be designed to be streamlined. At least a nacelle may be asymmetrical about a plane comprising the longitudinal axis of the engine and the yaw axis of aircraft 100.

With continued reference to FIG. 2, flight component 212 may include a propulsor. A “propulsor,” as used herein, is a component or device used to propel a craft by exerting force on a fluid medium, which may include a gaseous medium such as air or a liquid medium such as water. For the purposes of this disclosure, “substantially encapsulate” is the state of a first body (e.g., housing) surrounding all or most of a second body. A motor may include without limitation, any electric motor, where an electric motor is a device that converts electrical energy into mechanical work for instance by causing a shaft to rotate. A motor may be driven by direct current (DC) electric power; for instance, a motor may include a brushed DC motor or the like. A motor may be driven by electric power having varying or reversing voltage levels, such as alternating current (AC) power as produced by an alternating current generator and/or inverter, or otherwise varying power, such as produced by a switching power source. A motor may include, without limitation, a brushless DC electric motor, a permanent magnet synchronous motor, a switched reluctance motor, and/or an induction motor; persons skilled in the art, upon reviewing the entirety of this disclosure, will be aware of various alternative or additional forms and/or configurations that a motor may take or exemplify as consistent with this disclosure. In addition to inverter and/or switching power source, a circuit driving motor may include electronic speed controllers or other components for regulating motor speed, rotation direction, torque, and/or dynamic braking. Motor may include or be connected to one or more sensors detecting one or more conditions of motor; one or more conditions may include, without limitation, voltage levels, electromotive force, current levels, temperature, current speed of rotation, position sensors, and the like. For instance, and without limitation, one or more sensors may be used to detect back-EMF, or to detect parameters used to determine back-EMF, as described in further detail below. One or more sensors may include a plurality of current sensors, voltage sensors, and speed or position feedback sensors. One or more sensors may communicate a current status of motor to a flight controller and/or a computing device; computing device may include any computing device as described in this disclosure, including without limitation, a flight controller.

With continued reference to FIG. 2, a motor may be connected to a thrust element. Thrust element may include any device or component that converts mechanical work, for example of a motor or engine, into thrust in a fluid medium. Thrust element may include, without limitation, a device using moving or rotating foils, including without limitation one or more rotors, an airscrew or propeller, a set of airscrews or propellers such as contra-rotating propellers or co-rotating propellers, a moving or flapping wing, or the like. Thrust element may include without limitation a marine propeller or screw, an impeller, a turbine, a pump-jet, a paddle or paddle-based device, or the like. Thrust element may include a rotor. Persons skilled in the art, upon reviewing the entirety of this disclosure, will be aware of various devices that may be used as thrust element. A thrust element may include any device or component that converts mechanical energy (i.e., work) of a motor, for instance in form of rotational motion of a shaft, into thrust within a fluid medium. As another non-limiting example, a thrust element may include an eight-bladed pusher propeller, such as an eight-bladed propeller mounted behind the engine to ensure the drive shaft is in compression.

With continued reference to FIG. 2, in nonlimiting embodiments, at least a flight component 212 may include an airbreathing engine such as a jet engine, turbojet engine, turboshaft engine, ramjet engine, scramjet engine, hybrid propulsion system, turbofan engine, or the like. At least a flight component 212 may be fueled by any fuel described in this disclosure, for instance without limitation Jet-A, Jet-B, diesel fuel, gasoline, or the like. In nonlimiting embodiments, a jet engine is a type of reaction engine discharging a fast-moving jet that generates thrust by jet propulsion. While this broad definition can include rocket, water jet, and hybrid propulsion, the term jet engine, in some cases, refers to an internal combustion airbreathing jet engine such as a turbojet, turbofan, ramjet, or pulse jet. In general, jet engines are internal combustion engines. As used in this disclosure, a “combustion engine” is a mechanical device that is configured to convert mechanical work from heat produced by combustion of a fuel. In some cases, a combustion engine may operate according to an approximation of a thermodynamic cycle, such as without limitation a Carnot cycle, a Cheng cycle, a Combined cycle, a Brayton cycle, an Otto cycle, an Allam power cycle, a Kalina cycle, a Rankine cycle, and/or the like. In some cases, a combustion engine may include an internal combustion engine. An internal combustion engine may include heat engine in which combustion of fuel occurs with an oxidizer (usually air) in a combustion chamber that comprises a part of a working fluid flow circuit. Exemplary internal combustion engines may without limitation a reciprocating engine (e.g., 4-stroke engine), a combustion turbine engine (e.g., jet engines, gas turbines, Brayton cycle engines, and the like), a rotary engine (e.g., Wankel engines), and the like. In nonlimiting embodiments, airbreathing jet engines feature a rotating air compressor powered by a turbine, with leftover power providing thrust through a propelling nozzle—this process may be known as a Brayton thermodynamic cycle. Jet aircraft may use such engines for long-distance travel. Early jet aircraft used turbojet engines that were relatively inefficient for subsonic flight. Most modern subsonic jet aircraft use more complex high-bypass turbofan engines. In some cases, they give higher speed and greater fuel efficiency than piston and propeller aeroengines over long distances. A few air-breathing engines made for highspeed applications (ramjets and scramjets) may use a ram effect of aircraft's speed instead of a mechanical compressor. An airbreathing jet engine (or ducted jet engine) may emit a jet of hot exhaust gases formed from air that is forced into the engine by several stages of centrifugal, axial or ram compression, which is then heated and expanded through a nozzle. In some cases, a majority of mass flow through an airbreathing jet engine may be provided by air taken from outside of the engine and heated internally, using energy stored in the form of fuel. In some cases, a jet engine may include are turbofans. Alternatively and/or additionally, jet engine may include a turbojets. In some cases, a turbofan may use a gas turbine engine core with high overall pressure ratio (e.g., 40:1) and high turbine entry temperature (e.g., about 1800 K) and provide thrust with a turbine-powered fan stage. In some cases, thrust may also be at least partially provided by way of pure exhaust thrust (as in a turbojet engine). In some cases, a turbofan may have a high efficiency, relative to a turbojet. In some cases, a jet engine may use simple ram effect (e.g., ramjet) or pulse combustion (e.g., pulsejet) to give compression. Persons skilled in the art, upon reviewing the entirety of this disclosure, will be aware of various devices that may be used as a thrust element.

With continuation reference to FIG. 2., an aircraft 100 may include a flight controller. S used in this disclosure, a is a device that generates signals for controlling at least a flight component 212 of an aircraft 100. In some cases, a flight controller includes electronic circuitry, such as without limitation a digital signal processor (DSP), an application-specific integrated circuit (ASIC), and/or a computing device. Flight controller may use sensor feedback to calculate performance parameters of motor, including without limitation a torque versus speed operation envelope. Persons skilled in the art, upon reviewing the entirety of this disclosure, will be aware of various devices and/or components that may be used as or included in a motor or a circuit operating a motor, as used and described in this disclosure.

With continued reference to FIG. 2, computing device may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device may include a single computing device operating independently, or may include two or more computing device operating in concert, in parallel, sequentially or the like; two or more computing devices may be included together in a single computing device or in two or more computing devices. Computing device may interface or communicate with one or more additional devices as described below in further detail via a network interface device. Network interface device may be utilized for connecting computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device may include but is not limited to, for example, a computing device or cluster of computing devices in a first location and a second computing device or cluster of computing devices in a second location. Computing device may include one or more computing devices dedicated to data storage, security, distribution of traffic for load balancing, and the like. Computing device may distribute one or more computing tasks as described below across a plurality of computing devices of computing device, which may operate in parallel, in series, redundantly, or in any other manner used for distribution of tasks or memory between computing devices. Computing device may be implemented using a “shared nothing” architecture in which data is cached at the worker, in an embodiment, this may enable scalability of system and/or computing device.

With continued reference to FIG. 2, computing device may be designed and/or configured to perform any method, method step, or sequence of method steps in any embodiment described in this disclosure, in any order and with any degree of repetition. For instance, computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 2, BWB 108 aircraft may have distinct wing and body structures, which are smoothly blended together with no clear dividing line or boundary feature between wing and fuselage. This contrasts with a flying wing, which has no distinct fuselage, and a lifting body, which has no distinct wings. A BWB 108 design may or may not be tailless. One potential advantage of a BWB 108 may be to reduce wetted area and any accompanying drag associated with a conventional wing-body junction. In some cases, a BWB 108 may also have a wide airfoil-shaped body, allowing entire aircraft to generate lift and thereby facilitate reduction in size and/or drag of wings. In some cases, a BWB 108 may be understood as a hybrid shape that resembles a flying wing, but also incorporates features from conventional aircraft. In some cases, this combination may offer several advantages over conventional tube-and-wing airframes. In some cases, a BWB airframe 404 may help to increase fuel economy and create larger payload (cargo or passenger) volumes within the BWB. BWB 108 may allow for advantageous interior designs. For instance, cargo can be loaded and/or passengers can board from the front or rear of the aircraft. A cargo or passenger area may be distributed across a relatively wide (when compared to conventional tube-wing aircraft) fuselage, providing a large usable volume. In some embodiments, passengers seated within an interior of aircraft, real-time video at every seat can take place of window seats.

With continued reference to FIG. 2, BWB 108 of aircraft 100 may include a nose portion 208. A “nose portion,” for the purposes of this disclosure, refers to any portion of aircraft 100 forward of the aircraft’s fuselage 128. Nose portion 208 may comprise a cockpit (for crewed aircraft), canopy, aerodynamic fairings, windshield, and/or any structural elements required to support mechanical loads. Nose portion 208 may also include pilot seats, control interfaces, gages, displays, inceptor sticks, throttle controls, collective pitch controls, and/or communication equipment, to name a few. Nose portion 208 may comprise a swing nose configuration. A swing nose may be characterized by an ability of the nose to move, manually or automatedly, into a differing orientation than its flight orientation to provide an opening for loading a payload into aircraft fuselage from the front of the aircraft. Nose portion 208 may be configured to open in a plurality of orientations and directions. In some exemplary embodiments, nose may be configured to house landing gear, e.g., nose landing gear. Landing gear may include any landing gear described in this disclosure.

Now referring to FIG. 3, an exemplary embodiment of an airframe 312 of a blended wing body freighter 300 is shown. In an embodiment, a blended wing body freighter 300 (also referred to in this disclosure as a “freighter”) is a freighter having a blended wing body. As used in this disclosure, a “freighter” is an aircraft configured to store and transport cargo. Freighter 300 may include a fuselage 316 having an interior cavity. Fuselage 316 may include an cargo bay 308, which may include at least a portion of an interior cavity of fuselage, that is configured to hold cargo 320. Cargo 320 may be disposed within cargo bay 308 of airframe 312 of freighter 300. For the purposes of this disclosure, a “cargo bay” is a portion of an interior cavity of an aircraft configured to store cargo during transportation. In some nonlimiting embodiments, the overall cargo capacity of freighter 300 may be substantially proportional to a surface area of a base, such as a deck 304, of airframe 312. In some cases, a post may be supporting a floor (e.g.,deck 304) of freighter 300, or in other words a surface on which payload, such as cargo, may rest on due to gravity when within an aircraft 300 is in its level flight orientation or sitting on ground. In some embodiments, a post may act similarly to stringer in that it is configured to support axial loads in compression due to a load being applied parallel to its axis due to, for example and without limitation, a heavy object being placed on a floor of freighter 300. A beam may be disposed in or on any portion of fuselage of aircraft that requires additional bracing, specifically when disposed transverse to another structural element, like a post, which would benefit from support in that direction, opposing applied force. A beam may be disposed in a plurality of locations and orientations within a fuselage as necessitated by operational and constructional requirements.

In other nonlimiting embodiments, the overall cargo capacity of freighter 300 may include at least a portion of a surface area of deck 304. Cargo bay 308 may include a volumetric space used for cargo storage. In one or more embodiments, a volumetric space may include at least a portion of a width w of interior cavity, a height h of interior cavity, and a length l of interior cavity, as previously described in FIGS. 1A-1B. In various embodiments, a width w of interior cavity may run parallel to a lateral axis of freighter 300 that extends wing-to-wing of a BWB of freighter 300. In various embodiments, a height h of interior cavity may extend from a surface of deck 304 to a ceiling of freighter 300, such as toward a skin of freighter 300. In various embodiments, a length l of interior cavity may run along a longitudinal axis of freighter 300 that extends nose-to-tail of freighter 300. In one or more embodiments, cargo density of freighter 300 may include a range of 6 lb/ft³-11 lb/ft³. Cargo bay 308 may be configured to include receptacles for fuel tanks, batteries, fuel cells, or other energy sources as described in this disclosure. In one or more nonlimiting embodiments, M1 containers may be oriented 125” wide, 96” long and 96” high. In various embodiments, interior cavity may include a useable height (e.g., ceiling height h) set to accommodate 96-inch height throughout the bay or cabin and in structural openings to permit lateral and longitudinal motion of containers. In one or more embodiments, height h of interior cavity may include a total height of a height of a lower portion (e.g., lower portion 144 of FIG. 1B) and a total height of upper portion (e.g., upper portion 140 of FIG. 1B). In nonlimiting embodiments, height h may include ceiling height, which includes a distance from a base, such as deck 304, to interior surface of an upper skin of airframe 312.

In one or more nonlimiting embodiments, freighter 300 may retain an outboard volume for LD-3 containers and include securing systems or mechanisms to restrain LD-3, such as four LD-3 containers, containers in a front area of cargo bay 308. In one or more embodiments, M1 containers may be used for cargo storage in cargo bay 308 because they are rectangular and a suitable shape for efficient filling of a cargo compartment (e.g., usable space for cargo storage of interior cavity) of cargo bay 308. However, other container shapes may also be used for cargo storage. For example, and without limitation, containers may include one or more chamfered edges. In a nonlimiting embodiment, a chamfered edge of a container may allow a container to fit within a cylindrical fuselage with, for example a substantially circular or elliptical cross section with reduced volumetric efficiency. As understood by one of ordinary skill in the art, interior cavity and/or cargo compartment may be various shapes and sizes, such as, for example, spherical, cylindrical, cubic, and the like. In various nonlimiting embodiments, a length l of cargo bay may be configured to hold five M1 containers between an aft bulkhead, such as aft bulkhead 118 of FIG. 1B, and a main transverse bulkhead of airframe 312. An additional three M1 containers may fit on a centerline of a forward portion of interior cavity 136 while leaving enough room between the forward container and a cockpit bulkhead, such as cockpit bulkhead 122 of FIG, 1B, for a cross-aisle and some supernumerary seats.

Still referring to FIG. 3, a passenger compartment, such as passenger compartment 104 shown in FIGS. 1A-1B, may be positioned above cargo 320, thus, allowing for the same amount of cargo to be held by freighter 320 while also allowing for the transportation of passengers. A height h of cargo bay 308 may allow for a passenger compartment to be disposed within an upper portion of freighter 300 while still allowing for ample headspace for passengers. The size of passenger compartment relative to interior cavity may be based on requirements for passenger capacity versus cargo capacity. For example, and without limitation, if more cargo is required to be transported, then passenger compartment may only hold several passengers to allow for more storage of cargo.

Still referring to FIG. 3, fuselage 316 may include cargo doors, which allow for traversing of cargo into and out of freighter 300. Cargo doors of freighter 300 may be placed in various locations of BWB of freighter 300 to allow for loading of cargo into freighter 300. For example, and without limitation, a main cargo door of fuselage 316 may be located on a left side of BWB 104 in alignment with the front row of M1 containers in main portion of interior cavity. This location may be behind and clear of a primary passenger door on the same side. In another example, and without limitation, a nose portion of freighter 300 may swing open to provide an opening, allowing for cargo to be moved into and out of cargo bay 308. In another example, and without limitation, cargo doors may include openings disposed within fuselage 316 of freighter 300. In one or more embodiments, freighter 300 may include cargo systems and/or devices, such as mechanisms used for loading and/or securing cargo within cargo bay 308 of freighter 300. For example, and without limitation, a cargo loading system may include a conveyor belt configured to move cargo from a first location (e.g., a location outside of fuselage 316) to a second location (e.g., a location inside of fuselage 316, such as interior cavity). In another example, and without limitation, a securing mechanism may include a strap or hook that a selectively secures cargo 320 to an interior surface (e.g., floor, wall, ceiling, and the like) of cargo bay 308.

Now referring to FIG. 4, an exemplary embodiment of a blended wing body tanker 400 is shown. In an embodiment, a blended wing body tanker is a tanker having a blended wing body. As used in this disclosure, a “tanker” or “tanker aircraft” is an aircraft configured to store, transport, and/or offload fuel. In some cases, a tanker may be used to offload fuel to another aircraft, for example in flight, thereby increasing flight time and/or range of the other aircraft. As previously mentioned, aircraft 100 may include a blended wing body tanker. Blended wing body tanker 400 (also referred to in this disclosure as a “tanker”) may include a first fuel store 420a–b within blended wing body 404. As used in this disclosure, a “fuel store” is a container for fuel, such as without limitation a tank, a bladder, a reservoir, and the like. First fuel store 420a–b may be located anywhere within blended wing body 404. For example, first fuel store 420a–b may be located in one or more of main body 408, a wing 412a–b, and/or a transition 416a–b. First fuel store may be located within each transition 416a–b and wing 412a–b of blended wing body. In some embodiments, first fuel may include one or more of a kerosene-based fuel and a gasoline-based fuel. First fuel store and first fuel may include any fuel store or fuel described in this disclosure.

With continued reference to FIG. 4, aircraft 400 may include a fuel offloading system 424. As used in this disclosure, a “fuel offloading system” is a system configured to offload fuel from a tanker. In some cases, a fuel offloading system 424 may be configured to offload during flight. In some cases, a fuel offloading system may be configured to offload into another aircraft, thereby refueling the other aircraft. Fuel offloading system 424 may be operatively connected to first fuel store 420 and configured to offload first fuel to a receiving aircraft in flight. Fuel offloading system 420 may include a boom and/or a probe-and drogue to connect with receiving aircraft. Fuel offloading system 420 may include any fuel offloading system described in this disclosure.

With continued reference to FIG. 4, aircraft 400 may include a second fuel store 428. Second fuel store 428 may be located anywhere within blended wing body 404. For example, second fuel store 428 may be located in one or more of main body 408, a wing 412a–b, and/or a transition 416a–b. As shown in FIG. 4, second fuel store may be located within main body 404 of blended wing body 408. In some cases, second fuel store 428 may be configured to store a second fuel different from first fuel. For example, in some cases, second fuel may include one or more of liquid hydrogen fuel and liquid natural gas fuel, while first fuel includes one or more of a kerosene-based fuel and a gasoline-based fuel. Second fuel store and second fuel may include any fuel store or fuel described in this disclosure.

Still referring to FIG. 4, in some embodiments, second fuel store 428 may additionally include an insulated wall. As used in this disclosure in a thermal context, an “insulated wall” is any structure configured to restrict, slow, minimize, or otherwise limit a flow of heat. In some cases, an insulated wall may include a hermetically sealed portion, through which heat transfer by convection is limited. For example, in some cases an insulated wall may include a hermetically sealed portion containing one or more of a vacuum and gas having a low heat transfer properties (e.g., argon, krypton, and the like). As used in this disclosure, a “vacuum” is a pressure below that of the cabin pressure. Alternatively or additionally, in some cases, insulated wall may include insulation. As used in this disclosure in a thermal context, “insulation” is any material that restricts, slows, minimizes, or otherwise limits a flow of heat. In some cases, insulated wall of second fuel store 428 may be configured to limit heat transfer to second fuel. Insulated wall and insulation may include any thermal insulation means described in this disclosure. Additional disclosure related to fuel offload system technology may be found in U.S. Pat. App. No. 17/672,829 title “BLENDED WING BODY AIRCRAFT WITH A FUEL CELL AND METHOD OF USE,” filed on February 16, 2022, and incorporated by reference, in its entirety, within this disclosure.

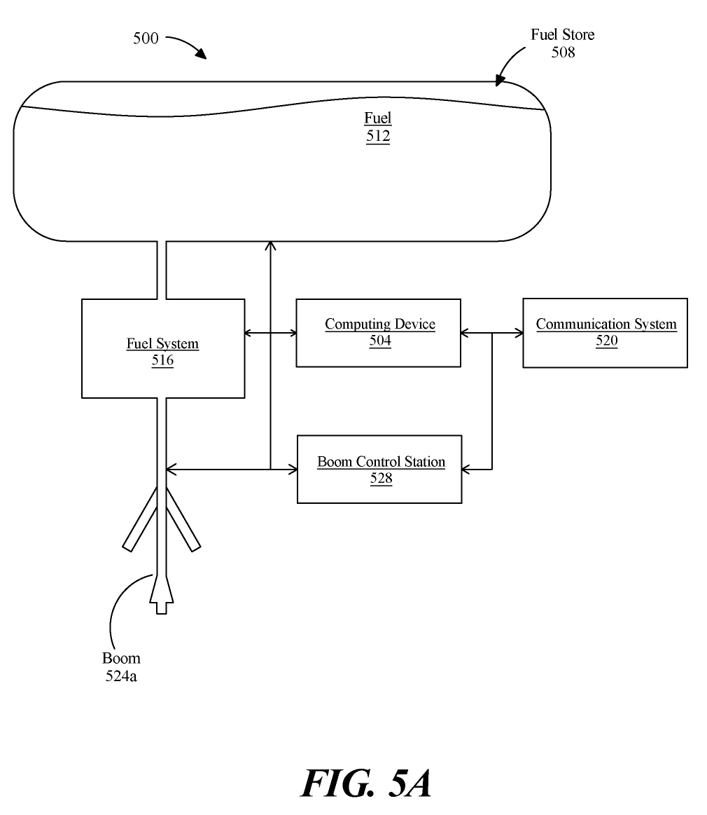

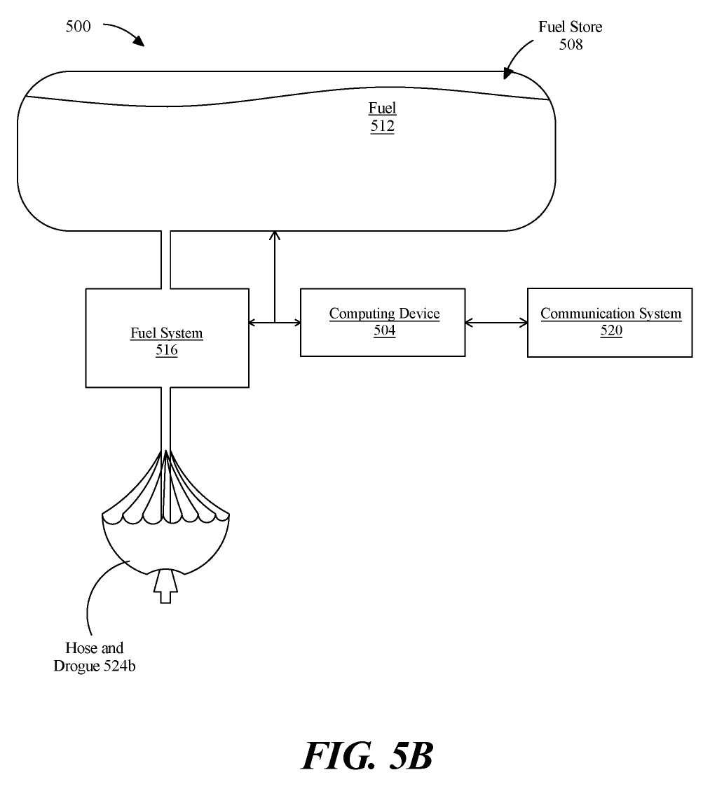

Referring now to FIGS. 5A–5B, exemplary fuel offloading systems 500 are illustrated by way of block diagrams. For the purposes of this disclosure, a “fuel offloading system” is a system used to transfer fuel from one aircraft to another during flight. FIG. 5A illustrates an exemplary fuel offloading system 500 with a boom. FIG. 5B illustrates an exemplary fuel offloading system 500 with a hose and drogue. System 500 may include a computing device 504. Computing device 504 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device 504 may include a single computing device operating independently, or may include two or more computing device operating in concert, in parallel, sequentially or the like; two or more computing devices may be included together in a single computing device or in two or more computing devices. Computing device 504 may interface or communicate with one or more additional devices as described below in further detail via a network interface device. Network interface device may be utilized for connecting computing device 504 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 504 may include but is not limited to, for example, a computing device or cluster of computing devices in a first location and a second computing device or cluster of computing devices in a second location. Computing device 504 may include one or more computing devices dedicated to data storage, security, distribution of traffic for load balancing, and the like. Computing device 504 may distribute one or more computing tasks as described below across a plurality of computing devices of computing device, which may operate in parallel, in series, redundantly, or in any other manner used for distribution of tasks or memory between computing devices. Computing device 504 may be implemented using a “shared nothing” architecture in which data is cached at the worker, in an embodiment, this may enable scalability of system 500 and/or computing device.

With continued reference to FIGS. 5A–5B, computing device 504 may be designed and/or configured to perform any method, method step, or sequence of method steps in any embodiment described in this disclosure, in any order and with any degree of repetition. For instance, computing device 504 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 504 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIGS. 5A–5B, fuel offloading system 500 may include a fuel store 508 configured to store a fuel 512. Fuel store 508 may include any fuel store described in this disclosure, including without limitation a tank, a bladder, a reservoir, or the like. In some embodiments, fuel store 508 may removably attached to aircraft 100, for example within blended wing body 104. In some cases, fuel store 508 may be removably installed (along with fuel offloading system 500) in order to allow aircraft to operate as a tanker and removed for the aircraft to serve other purposes. In some cases, installation of fuel store 508 may be achieved by way of one or more cargo doors through which the fuel store 508 may enter blended wing body. Cargo door may include any door described in this disclosure, including with reference to FIG. 4. In some cases, aircraft 100 may operate as a personnel or cargo transport, for instance with fuel offloading system 500 and/or fuel store 508 removed and or made inoperable. In some cases, fuel store 512 may include one or more fuel sensors, such as without limitation level sensors and/or temperature sensors. Fuel sensors may be in communication with computing device 504. With continued reference to FIGS. 5A–5B, fuel offloading system 500 may include a fuel system 516. As used in this disclosure, a “fuel system” is any system that is configured to provide for the conveyance of fuel. Fuel system 516 may include flow control devices, such as without limitation valves, regulators, and the like. As used in this disclosure, a “valve” is a component that controls fluidic communication between two or more components. Exemplary non-limiting valves include directional valves, control valves, selector valves, multi-port valves, check valves, and the like. Valves may include any suitable valve construction including ball valves, butterfly valves, needle valves, globe valves, gate valves, wafer valves, regulator valves, and the like. Valves may be included in a manifold of a fluidic circuit, for example allowing for multiple ports and flow paths. Valves may be actuated by any known method, such as without limitation by way of hydraulic, pneumatic, mechanical, or electrical energy. For instance, in some cases, a valve may be actuated by an energized solenoid or electric motor. Valve actuators and thereby valves themselves, may be controlled by computing device 504. Computing device 504 may be in communication with valve, for example by way of one or more of electrical communication, hydraulic communication, pneumatic communication, mechanical communication, and the like. In some cases, computing device 104 may be in communication with one or more components (e.g., valve, pump, sensors, and the like) by way of one or more networks, including for example wireless networks and controller area networks (CANs). Fuel system 516 may include pressurization or flow inducing devices, such as without limitation pumps. Pump may include a substantially constant pressure pump (e.g., centrifugal pump) or a substantially constant flow pump (e.g., positive displacement pump, gear pump, and the like). Pump can be hydrostatic or hydrodynamic. As used in this disclosure, a “pump” is a mechanical source of power that converts mechanical power into fluidic energy. A pump may generate flow with enough power to overcome pressure induced by a load at a pump outlet. A pump may generate a vacuum at a pump inlet, thereby forcing fluid from a reservoir into the pump inlet to the pump and by mechanical action delivering this fluid to a pump outlet. Hydrostatic pumps are positive displacement pumps. Hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. Pump may be powered by any rotational mechanical work source, for example without limitation and electric motor or a power take off from an engine. Pump may be in fluidic communication with at least a reservoir. In some cases, reservoir may be unpressurized and/or vented. Alternatively, reservoir may be pressurized and/or sealed. In some cases, pump may be communicative with computing device 504. Computing device 504 may control pump, for instance by way of a control signal. In some cases, fuel system 516 may include one or more fuel sensors. As used in this disclosure, a “fuel sensor” is a device that detects a fuel variable based upon a phenomenon associated with the fuel. Exemplary non-limiting fuel sensors include flow sensors, pressure sensors, level sensors, temperature sensors, and the like. Sensors may communicate with computing device 504 using one or more signals representative of fuel variable. Sensors and/or pumps may be in communication with computing device 504 by way of electrical communication, optical communication, mechanical communication, fluidic communication or the like. In some cases, components may be communicative with computing device 504 by way of at least a network, for example a local area network, a controller area network, or the like. In some cases, computing device 504 may be communicative by way of one or more communication protocols, such as without limitation ethernet, serial, and parallel communication protocols. As used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like.

With continued reference to FIGS. 5A–5B, fuel offloading system 500 may include a communication system 520. Communication system 520 may be configured to communicate with a device (communication system e.g.,) on receiving aircraft (i.e. aircraft being refueled by aircraft 100). Communication system 520 may communicate by way of radio communication, optical communication, cellular communication, satellite communication, or the like. In some cases, communication system 520 may include a network interface card; the communication system 520 may communicate by way of one or more networks. In some cases, information communicated by way of communication system 520 may be automatically generated, for example by computing device 504, flight controller, or the like. Alternatively or additionally, in some cases, information communicated by way of communication system 520 to receiving aircraft may be at least partially human generated, for instance by a crewmember of aircraft 100. In some cases, communication system 520 may communicate by way of one or more signals.

With continue reference to FIGS. 5A–5B, fuel offloading system 500 may include a fuel supply connection 524a–b. As used in this disclosure, a “fuel supply connection” is a fluidic conduit connecting fuel offloading system 500 and a receiving aircraft. As used in this disclosure, a “receiving aircraft” is an aircraft that has, is going to, or is currently being refueled by aircraft 100 and is thus receiving. Aircraft 100 may have one or more fuel supply connections 524a–band therefore be able to fuel one or more receiving aircraft at a time. In some cases, tanker may have a fuel supply connection 524a–b generally at center of aircraft. Alternatively or additionally, in some cases, aircraft 100 may have a fuel supply connection 524a–b laterally aligned with a point along one or both wings (or transitions) and therefore off-center. In some cases, a fuel supply connection 524a–b may have a valve located at a distal end. Valve (e.g., poppet valve) may be configured to open automatically when fuel supply connection has mated with receiving vehicle. In some cases, toggles may connect fuel supply connection with receiving aircraft. In some cases, fuel supply connection 524a–b may mate with a (female) receptacle in receiving aircraft. Alternatively or additionally, fuel supply connection 524a–b may mate with a (male) probe in receiving aircraft.

Referring to FIG. 5A, fuel supply connection includes a boom 524a. As used in this disclosure a “boom” is a rigid fuel supply connection. Boom 524a may be configured to extend and insert into a receptacle on receiving aircraft. In some cases, boom 524a may include a flying boom. As used in this disclosure, a “flying boom” is a rigid, telescoping tube with movable flight control surfaces. In some cases, boom 524a may be operated by from a boom control station 528. In some cases, a boom operator may be located within boom control station 528 on tanker aircraft 100. Alternatively or additionally, boom control station 528 may be remotely located or include a computing device configured to automatically control boom 524a. In some cases, boom 524a may include flight control surfaces (e.g., small movable airfoils that are often in a V-tail configuration) configured to move the boom by through aerodynamic forces. In some cases, flight control surfaces may be actuated using an actuator and controlled from boom control station 528, for example by boom operator using a control stick. In some cases, boom 524a may telescope, effectively lengthening the boom 524a. Boom 524a may telescope through actuation of one or more actuators controlled from control station 528, for example by boom operator.

With continued reference to FIGS. 5A–5B, an actuator may include a component of a machine that is responsible for moving and/or controlling a mechanism or system. An actuator may, in some cases, require a control signal and/or a source of energy or power. In some cases, a control signal may be relatively low energy. Exemplary control signal forms include electric potential or current, pneumatic pressure or flow, or hydraulic fluid pressure or flow, mechanical force/torque or velocity, or even human power. In some cases, an actuator may have an energy or power source other than control signal. This may include a main energy source, which may include for example electric power, hydraulic power, pneumatic power, mechanical power, and the like. In some cases, upon receiving a control signal, an actuator responds by converting source power into mechanical motion. In some cases, an actuator may be understood as a form of automation or automatic control.

With continued reference to FIGS. 5A–5B, in some embodiments, actuator may include a hydraulic actuator. A hydraulic actuator may consist of a cylinder or fluid motor that uses hydraulic power to facilitate mechanical operation. Output of hydraulic actuator may include mechanical motion, such as without limitation linear, rotatory, or oscillatory motion. In some cases, hydraulic actuator may employ a liquid hydraulic fluid. As liquids, in some cases. are incompressible, a hydraulic actuator can exert large forces. Additionally, as force is equal to pressure multiplied by area, hydraulic actuators may act as force transformers with changes in area (e.g., cross sectional area of cylinder and/or piston). An exemplary hydraulic cylinder may consist of a hollow cylindrical tube within which a piston can slide. In some cases, a hydraulic cylinder may be considered single acting. Single acting may be used when fluid pressure is applied substantially to just one side of a piston. Consequently, a single acting piston can move in only one direction. In some cases, a spring may be used to give a single acting piston a return stroke. In some cases, a hydraulic cylinder may be double acting. Double acting may be used when pressure is applied substantially on each side of a piston; any difference in resultant force between the two sides of the piston causes the piston to move.

With continued reference to FIGS. 5A–5B, in some embodiments, actuator may include a pneumatic actuator. In some cases, a pneumatic actuator may enable considerable forces to be produced from relatively small changes in gas pressure. In some cases, a pneumatic actuator may respond more quickly than other types of actuators, for example hydraulic actuators. A pneumatic actuator may use compressible flued (e.g., air). In some cases, a pneumatic actuator may operate on compressed air. Operation of hydraulic and/or pneumatic actuators may include control of one or more valves, circuits, fluid pumps, and/or fluid manifolds.

With continued reference to FIGS. 5A–5B, in some cases, actuator may include an electric actuator. Electric actuator may include any of electromechanical actuators, linear motors, and the like. In some cases, actuator may include an electromechanical actuator. An electromechanical actuator may convert a rotational force of an electric rotary motor into a linear movement to generate a linear movement through a mechanism. Exemplary mechanisms, include rotational to translational motion transformers, such as without limitation a belt, a screw, a crank, a cam, a linkage, a scotch yoke, and the like. In some cases, control of an electromechanical actuator may include control of electric motor, for instance a control signal may control one or more electric motor parameters to control electromechanical actuator. Exemplary non-limitation electric motor parameters include rotational position, input torque, velocity, current, and potential. electric actuator may include a linear motor. Linear motors may differ from electromechanical actuators, as power from linear motors is output directly as translational motion, rather than output as rotational motion and converted to translational motion. In some cases, a linear motor may cause lower friction losses than other devices. Linear motors may be further specified into at least three different categories, including flat linear motor, U-channel linear motors and tubular linear motors. Linear motors may controlled be directly controlled by a control signal for controlling one or more linear motor parameters. Exemplary linear motor parameters include without limitation position, force, velocity, potential, and current.

With continued reference to FIGS. 5A–5B, in some embodiments, an actuator may include a mechanical actuator. In some cases, a mechanical actuator may function to execute movement by converting one kind of motion, such as rotary motion, into another kind, such as linear motion. An exemplary mechanical actuator includes a rack and pinion. In some cases, a mechanical power source, such as a power take off may serve as power source for a mechanical actuator. Mechanical actuators may employ any number of mechanism, including for example without limitation gears, rails, pulleys, cables, linkages, and the like.

Referring now to FIG. 5B, fuel supply connection may include a hose and drogue. As used in this disclosure, a “hose and drogue” is a flexible hose that trails from tanker aircraft 100. Drogue (i.e. para-drogue or basket) includes a fitting resembling a shuttlecock, attached with a valve to flexible hose. Drogue may stabilize hose in flight. In some cases, drogue may provide a funnel to aid insertion of receiver aircraft probe into the hose. In some cases, hose connects to a Hose Drum Unit (HDU). When not in use, hose/drogue may be reeled completely into HDU. In some cases, receiver aircraft has a probe, which is a rigid, protruding, pivotable, or retractable arm proximal the receiving aircraft's nose or fuselage to make fluidic connection with hose. In some embodiments, probe may be retractable and retracted when not in use.

Additional disclosure is provided below to further describe the disclosure and some exemplary embodiments. In some embodiments, aircraft may be powered by liquid hydrogen (LH2) and deliver kerosene-based fuel to receiving aircraft. In some cases, an LH2-powered BWB tanker can deliver more fuel to a greater radius than a kerosene-powered BWB tanker. As described above, LH2 is relatively lighter and thus permits BWB to carry greater kerosene-based fuel weight without sacrificing range. Alternatively or additionally, in some cases, with a small sacrifice in kerosene-based fuel weight (and an equally small LH2 weight increase), tanker can offload fuel over longer ranges. In some embodiments, additional volume required by LH2 is accommodated by a comparatively large internal volume of BWB configuration. In some embodiments, BWB tanker may operate using LH2 fuel, providing energy for all of its own needs, such as without limitation propulsion systems, avionics, controls, environmental control systems, lighting, tanker systems, and the like.

In some embodiments, BWB aircraft may be configured to carry a relatively large quantity and weight of kerosene-based fuel. In some cases, this fuel may be accessible in flight by tanker systems including, without limitation, fuel lines, pumps, boom(s) and hose-and-drogue(s), tanker systems to permit offloading of fuel, boom operator station, and the like.

In some embodiments, BWB aircraft may be configured to transport cargo. For instance, BWB may be configured with cargo systems. Exemplary cargo systems may include without limitation one or more cargo compartments, cargo restraining means (e.g., cargo floor with rollers, rails, locks and the like), a forward cargo barrier (configured to protect pilots and crew), cargo doors and openings (configured to permit cargo to be loaded, distributed within the airplane, and unloaded), and the like.

In some embodiments, BWB aircraft may include a hybrid tanker. As used in this disclosure, a “hybrid tanker” is a tanker that may be powered by more than one energy (e.g., fuel) source. For instance, in an exemplary embodiment, an LH2 powered tanker may also be able to operate on kerosene-based fuel; as a result, the tanker could provide kerosene at even greater ranges, although that range would come at a cost of offload capability. In some cases, propulsion systems comprise at least an engine capable of operating using at least two different types of fuel (e.g., LH2 and kerosene-based fuel or LNG and kerosene-based fuel). In some cases, a hybrid tanker may have an added advantage of extremely great ferry ranges. As used in this disclosure, “ferrying” an airplane refers to flying an airplane to a destination without payload, for instance for the purpose of operational relocation or repositioning.

In yet another exemplary embodiment, aircraft may be powered using liquid natural gas (LNG) and may carry a kerosene-based fuel payload (e.g., Jet-A). Like LH2, LNG is less dense than kerosene-based fuels, but has a higher mass energy density (energy per unit weight). Although differences between LNG and kerosene-based fuel are not as great as differences between LH2 and kerosene-based fuel.

In still another exemplary embodiment, aircraft may be propelled by hydrogen and/or kerosene, while delivering only kerosene. In some cases, an engine configured to propel aircraft 100 may operate on hydrogen and/or kerosene. In some cases, engine may be hot-swapped between fuels, for example while in flight and operating. In some cases, enabling aircraft 100 to fly on kerosene can provide a benefit by extending its service radius, for instance at an expense of reduced fuel delivered. In some cases, enabling tanker 10 to fly on kerosene may enable the tanker to operate from bases that cannot provide hydrogen fuel. In some cases, enabling aircraft 100 to fly with by consuming multiple fuel types (e.g., hydrogen and kerosene) allows multiple fuel types to be used for reserve fuel. Airplanes generally carry substantial reserve fuel sufficient to fly a certain distance or to sustain flight for a certain period. If aircraft 100 can fly on two types of fuel, it may use either type for reserves. Hydrogen fuel is much lighter than kerosene so reserves in hydrogen may impose a reduced weight penalty to aircraft 100, thereby improving performance. In some cases, aircraft 100 fuel reserves may include hydrogen and/or natural gas.

In another exemplary embodiment, aircraft may be configured to deliver one or more hydrogen and/or natural gas to another aircraft in-flight. In some cases, performance of certain types of airplanes may benefit from use of hydrogen fuel. For example, some long endurance reconnaissance or signal relay airplanes may benefit from hydrogen’s light weight or its ability to be converted efficiently to electricity with a fuel cell. Such long endurance airplanes may benefit from in-flight refueling. Accordingly, in some cases, aircraft may be propelled by a first fuel, including kerosene and configured to deliver a second fuel, including one or more of hydrogen and natural gas.

In still another exemplary embodiment, aircraft may include one or more additional external fuel storage tanks. In some cases, external storage tanks may be mounted to an underside of a blended wing body aircraft, for instance under main body or wings. Alternatively or additionally, in some cases, external storage tanks may be mounted to a topside of a blended wing body aircraft, for instance on top of main body or wings. Alternatively or additionally, an external tank may be mounted aft of a blended wing body aircraft, for instance aft of main body or wings. In some cases, external tanks may optionally include a means of offload, for example a hose-and-drogue system. In some cases, external tanks may be aerodynamically shaped, for instance into a shape of a canoe or torpedo. In some cases, an external fuel tank may increase fuel storage by 1,000 to 100,000 kilograms for instance about 10,000 kilograms, about 20,000 kilograms, or about 30,000 kilograms. External fuel tanks may be configured to store any fuel described in this disclosure, for example kerosene-based fuels, hydrogen, and/or natural gas.

In still another embodiment, oxygen content of ullage within one or more fuel tanks is controlled (e.g., minimized). As used in this disclosure, “ullage” is empty volume within a tank (i.e., store or storage). In some cases, oxygen content may be reduced by addition of one or more inert gases, for example nitrogen. In some cases, one or more inert gases may be provided by a dedicated system. In some cases, one or more fuel tanks (i.e., stores) configured to carry a kerosene-based fuel or a gasoline-based fuel may be mounted to a dedicated system to control Oxygen content in ullage by filling the ullage with inert gas; this act may be referred to within this disclosure as “fuel tank inerting”.

In one or more embodiments, aircraft may include both cargo (or passenger) storage and fuel storage described in this disclosure. For instance, and without limitation, an aircraft tanker may include fuel storage in tanks of each wing of aircraft such that wing tanks are located outboard of a pressurized payload cabin of fuselage. Thus, pressurized cabin, which may include a main cabin and/or outboard bays used to store smaller containers (e.g., LD-3 containers), may still be used to store payload, such as cargo or people. In another instance, and without limitation, an outboard cargo volume, which may be used to hold smaller LD-3 containers, may be used for fuel storage to provide additional fuel volume if needed. In a nonlimiting exemplary embodiment, the combined left and right outboard storage may in a combined volume of 300,000 lb of fuel. This allows for sufficient storage of fuel in wing tanks and allowing for cargo storage in the main cabin of the fuselage. Thus, the interior region of the airplane within the pressurized volume can be used for fuel storage, cargo storage, and/or passenger seating. For example, and without limitation, main cabin(s) of aircraft may be used for carrying cargo, people (e.g., troops or commercial passengers), electronic systems and operators, or medical facilities (e.g., hospital airplane).

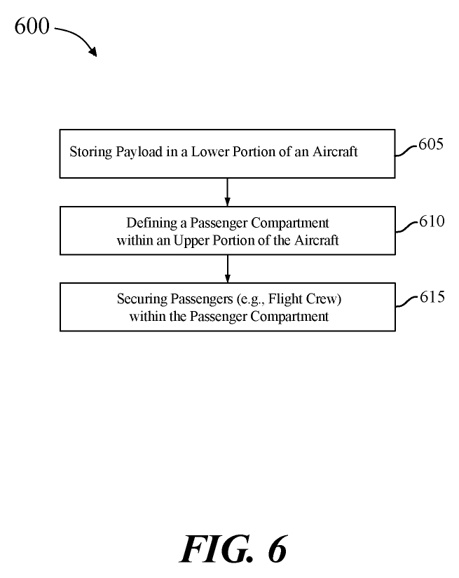

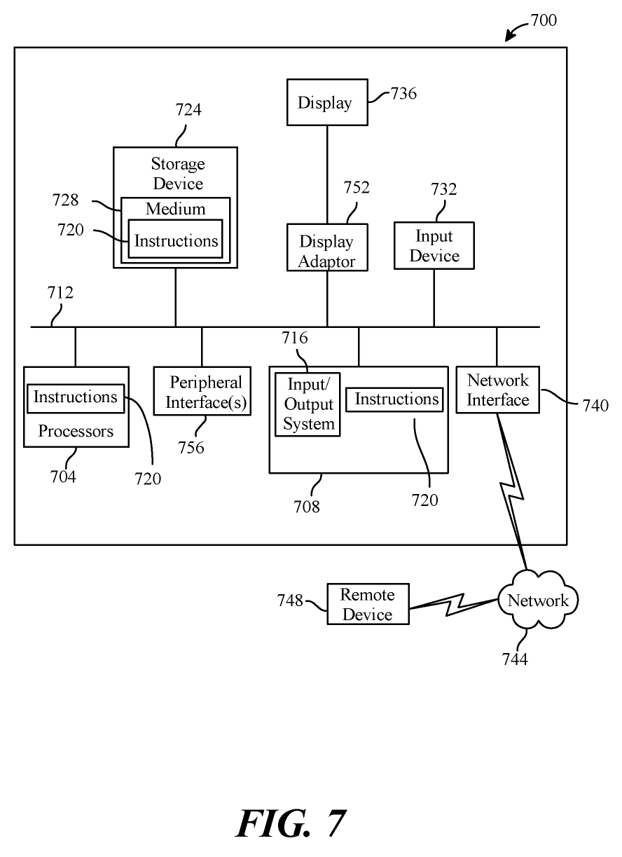

Now referring to FIG. 6, an exemplary method 600 of use of a blended body wing aircraft having a passenger compartment is shown. Method 600, at step 605, includes storing payload in a lower portion of a blended wing body of a blended wing body aircraft. Blended wing body aircraft may include any aircraft mentioned in this disclosure, such as FIGS. 1A-5B. Objects may include any object described in this disclosure, such as cargo, fuel, and the like.

As shown in block 610, method 600 may include defining a passenger compartment within an upper portion of the blended wing body, which is oriented above the lower portion, using one or more walls and a floor adjoining the one or more walls. Passenger compartment may include any passenger compartment described in this disclosure, such as in FIGS. 1A-5B. Passenger compartment may be configured to house members of flight crew for instance, for rest (non-duty) times. Passenger compartment may be disposed within a blended wing body aircraft, such as a freighter or tanker having a blended wing body.

As shown in block 615, method 600 may include securing one or more passengers within the passenger compartment during operation of the blended wing body aircraft. Passengers may include, for the purposes of this disclosure, flight crew members, including pilot, co-pilot, navigator, stewards, and the like. Operation of blended wing body aircraft may include flight. During flight, aircraft may conduct a special purpose such as transportation of cargo or in-flight refueling.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

We claim:

1. An aircraft comprising:
a Blended Wing Body (BWB) comprising a first wing portion and a second wing portion;
a first and a second structural component mechanically coupled to the BWB, each arranged along a respective parasagittal plane, wherein the first and second wing portions are laterally outward of the first and second structural components, respectively;
a flight deck at a forward end of the BWB, ahead of the first and second structural components, wherein the flight deck comprises a first floor defining a first floor plane;
a lower deck comprising a plurality of cargo bays;
a partial deck laterally spanning the first and second structural components and supporting a set of seats above the lower deck, wherein the partial deck comprises a second floor defining a second floor plane which is offset from the first floor plane; and
a set of engines above the BWB and rearward of the set of seats.

2. The aircraft of claim 1, wherein the BWB further comprises a fairing at the forward end of the BWB which at least partially encloses both the flight deck and the partial deck; wherein the fairing is mechanically coupled to the first and second structural components.

3. The aircraft of claim 1, wherein the first and second wing portions comprise a first and second wingtip, respectively, wherein the engines are forward of the wingtips.

4. The aircraft of claim 3, wherein a vertical projection of each engine of the set of engines is entirely within a vertical projection of the BWB.

5. The aircraft of claim 4, wherein the BWB further comprises a loading door, wherein a central axis of each engine of the set is closer to a midsagittal plane of the aircraft than a loading door is to the midsagittal plane.

6. The aircraft of claim 1, further comprising a set of stairs adjoining the partial deck.

7. The aircraft of claim 1, further comprising:
an aft wall of a passenger compartment coupled to the partial deck; and
an aft bulkhead which is rearward of the aft wall of the passenger compartment, wherein the BWB comprises an interior cavity which extends at least between the aft wall and the aft wall.

8. The aircraft of claim 7, wherein the interior cavity comprises passenger seating.

9. The aircraft of claim 8, wherein the passenger seating is positioned above cargo.

10. The aircraft of claim 7, further comprising: a second deck above the lower deck within the interior cavity.

11. The aircraft of claim 10, further comprising: a third and a fourth structural component mechanically coupled to the BWB, each arranged along a respective parasagittal plane, wherein the third and fourth structural components are laterally outward of the first and second structural components, respectively, wherein the lower deck and the second deck span the first, second, third, and fourth structural components within the interior cavity.

12. The aircraft of claim 11, wherein at least one of the lower deck and the second deck comprises a passenger seating area with a floor adjoining the first, second, third, and fourth structural components.

13. The aircraft of claim 11, wherein the set of engines are between the respective parasagittal planes of the third and fourth structural components.

14. The aircraft of claim 13, wherein the set of engines comprises a first engine between the respective parasagittal planes of the first and third structural components.

15. The aircraft of claim 11, wherein the lower deck extends between a cockpit bulkhead and the aft bulkhead of the aircraft.

16. The aircraft of claim 1, wherein the seats are within a sitting area of a passenger compartment on the partial deck, the passenger compartment further comprising:
a sleeping area, the sleeping area comprising at least one bunk; and
a partitioning wall, wherein the partitioning wall is configured to at least partially physically divide the sitting area and the sleeping area.

17. The aircraft of claim 1, further comprising a first fuel store located within the first wing portion.

18. The aircraft of claim 17, further comprising a second fuel store within the BWB, at least a portion of the second fuel store arranged ahead of the set of engines and between the respective parasagittal planes of the first and second structural components.

19. The aircraft of claim 1, wherein the set of seats comprise personnel seating.

20. The aircraft of claim 1, wherein a midsagittal plane of the aircraft intersects the flight deck, the lower deck, and the partial deck.
